(19) United States
(12) Patent Application Publication
(10) Pub. No.: US 2010/0202950 A1
(43) Pub. Date: Aug. 12, 2010

(54) Method of Preparing Heterogeneous Catalysts

(76) Inventors: Alexei A. Neverov, Kingston (CA); R. Stanley Brown, Kingston (CA); Mark F. Mohamed, Kingston (CA)

Correspondence Address: PARTEQ RESEARCH & DEVELOPMENT INNOVATIONS, QUEEN'S UNIVERSITY, KINGSTON, ON, K7L 3N6, CA

(21) Appl. No.: 12/612,364

(22) Filed: Nov. 4, 2009

Related U.S. Application Data
(60) Provisional application No. 61/112,342, filed on Nov. 7, 2008.

(30) Foreign Application Priority Data
Nov. 7, 2008 (CA) 2,643,509

(51) Int. Cl. C01B 25/14; C08G 79/00; B01J 31/06

(52) U.S. Cl. 423/303; 528/395; 502/152

(57) ABSTRACT

Efficient heterogeneous catalysts were prepared by derivatization and palladation of commercially available chloromethylated polystyrene, and derivatization and palladation of functionalized silica gels with benzylchloride pendant groups. Both polymer based and silica based heterogeneous catalysts exhibited catalytic activity. Catalytic activity was studied using methanolysis of commercially available P═S pesticides. Catalytic activity of catalysts immobilized on silica gel was greater than catalyst immobilized on polymer.

### RELATED APPLICATIONS

This application claims the benefit of the filing date of U.S. Provisional Patent Application No. 61/112,342, filed on Nov. 7, 2008, the contents of which are incorporated herein by reference in their entirety.

### FIELD OF THE INVENTION

The field of the invention is a method of providing a metal catalyst that is immobilized on a solid polymeric material. The field of the invention is a method of providing a palladium or platinum metal catalyst that is bonded to a solid polymeric material.

### BACKGROUND OF THE INVENTION

Homogeneous metal catalysts can be challenging to remove from reaction product(s), which makes product purification difficult. Stringent removal of metal catalyst is particularly required in manufacture of pharmaceuticals, flavours, cosmetics, fragrances, and agricultural chemicals. Heterogeneous metal catalysts (e.g., prepared by immobilizing metals such as palladium onto supported materials such as polymers, silica, Al₂O₃, and activated carbon) solve this metal contamination problem. Other advantages of heterogeneous catalysts include their recyclability, stability, and ability to prevent metal leaching.

While many examples of immobilized palladium catalysts of diverse processes exist, they have been generally investigated as potential catalysts for C—C bond forming reactions (Leadbeater, N. E.; Marco, M. Chem. Rev. 2002, 102, 3217), and the majority employ covalently anchored phosphines or imines for attachment of palladium to the surface. Some examples of immobilized (SCS)-type pincer palladacycles have been reported (Bergbreiter, D. E.; Osburn, P. L.; Wilson, A.; Sink, E. M. J. Am. Chem. Soc. 2000, 122, 9058; Bergbreiter, D. E.; Osburn, P. L.; Liu, Y.-S. J. Am. Chem. Soc. 1999, 121, 9531; and McNamara, C. E.; King, F.; Bradley, M. Tetrahedron Lett. 2004, 45, 8239).

A few examples of the immobilized ortho-palladated complexes that do exist have had variable success in their intended catalytic roles. In an example where the palladacycle was affixed to commercially available dicyclohexylphenyl phosphine functionalized polystyrene, there was an apparent turnover of the catalyst but no activity remained after the first run (Bedford, R. B.; Coles, S. J.; Hursthouse, M. B.; Scordia, V. J. M. J. Chem. Soc. Dalton Trans. 2005, 991). The ortho-palladated imine complexes developed by Nowotny et al. (Nowotny, M.; Hanefeld, U.; van Koningsveld, H.; Maschmeyer, T. Chem. Comm. 2000, 1877) and Bedford et al. (Bedford, R. B.; Cazin, C. S. J.; Hursthouse, M. B.; Light, M. E. Pike, K. J.; Wimperis, S. J. Organometal. Chem. 2001, 633, 173) are thermally unstable in the aqueous media used and all the observed catalysis was found to be due to free palladium metal or nanoparticles in solution. More recently; Garcia et al. reported that Suzuki-type cross-couplings could be promoted by an oxime carbapalladacycle immobilized on a variety of silica and polymeric surfaces (Baleizão, C.; Corma, A.; Garcia, H.; Leyva, A. J. Org. Chem. 2004, 69, 439; Corma, A.; Das, D.; Garcia, H.; Leyva, A. J. Catal. 2005, 229, 322; and Corma, A.; Garcia, H.; Leyva, A. J. Catal. 2006, 240, 87). While the SiO₂ anchored palladacycle showed no loss of activity after seven cycles (Baleizão, C.; Corma, A.; Garcia, H.; Leyva, A. J. Org. Chem. 2004, 69, 439), several of the polymeric materials exhibited decreased activity upon recycling.

Certain past examples of immobilized palladacycle complexes have relied on grafting an already prepared metal complex onto the surface of a solid support matrix. There is a need for a simple and inexpensive method for preparing immobilized and effective palladium and platinum catalysts.

### SUMMARY OF THE INVENTION

It is an object of certain embodiments of the present invention to provide a method of anchoring a metal catalyst to a solid support.

It is an object of certain embodiments of the present invention to provide heterogeneous catalysts.

A first aspect of the invention provides a method of preparing a heterogeneous catalyst comprising providing solid polymeric material comprising a main chain and a plurality of pendant groups, each pendant group having a first point of attachment suitable for bonding to a metal atom; reacting the solid polymeric material to provide modified solid polymeric material, wherein the modified solid polymeric material comprises a plurality of modified pendant groups, each having the first point of attachment and a second point of attachment suitable for bonding to a metal atom, which second point of attachment is proximal to the first point of attachment; reacting the modified solid polymeric material with metal; and obtaining a heterogeneous catalyst comprising metal bound to solid polymeric material at least the first and the second points of attachment of two or more of the modified pendant groups.

Another aspect of the invention provides a method of preparing a heterogeneous catalyst comprising providing solid polymeric material comprising a main chain and a plurality of pendant groups, each pendant group having a first point of attachment suitable for bonding to a metal atom; reacting the solid polymeric material to provide modified solid polymeric material, wherein the modified solid polymeric material comprises a plurality of modified pendant groups, each having the first point of attachment and a second point of attachment suitable for bonding to a metal atom, which second point of attachment is proximal to the first point of attachment; reacting the modified solid polymeric material with metal; and obtaining a heterogeneous catalyst comprising metal bound to solid polymeric material at least the first and the second points of attachment of one or more of the modified pendant groups.

In certain embodiments of the invention, the metal is metal ion, metal salt, or metal complex. The oxidation state of the metal may stay the same or may change depending on the specific metal atom. Oxidation states of catalytic metal atoms include, at least metal(0); metal (I); metal(II); metal(III); or metal(IV).

In another embodiment, the pendant groups are distributed along the main chain.

In another embodiment, a said pendant group comprises a functional moiety that is either zero or one atom from the main chain, wherein the functional moiety comprises the first point of attachment.

In yet another embodiment, the pendant groups are halobenzyl moieties. In another embodiment, the modified pendant groups are dimethylbenzylamine moieties.

In another embodiment, the heterogeneous catalyst comprises at least one-carbon-metal bond. In another embodiment, the heterogeneous catalyst comprises at least one heteroatom-metal bond.

In another embodiment, the heteroatom is nitrogen, oxygen, phosphorus, sulfur, selenium, or arsenic.

In another embodiment; the solid polymeric material is halomethylated polystyrene or halobenzyl-functionalized silica gel.

In another embodiment, reacting the modified solid polymeric material with metal further comprises solubilizing the metal prior to contacting it with the modified solid polymeric material. In certain embodiments, the metal is metal(II) halide and said solubilizing the metal(II) comprises: mixing the metal(II) halide in a solution of soluble silver salt; isolating solubilized metal(II) from silver halide precipitate; and reacting the solubilized metal(II) with the modified solid polymeric material.

In some embodiments, the metal(II) salt is a halide salt and may be a halide salt of palladium(II) or platinum(II).

In yet another embodiment, the heterogeneous catalyst comprises a metal bonded to the solid polymeric material via at least one carbon-metal bond and one heteroatom-metal bond. In some embodiments, the pendant groups comprise an aromatic ring having a halobenzyl substituent. The aromatic ring may be a heteroaromatic ring.

In embodiments of the invention, the heterogeneous catalyst comprises a plurality of metallocycles.

In a second aspect, the invention provides a method of immobilizing metal comprising providing a solid polymeric material comprising a main chain and a plurality of pendant groups, each pendant group having a first point of attachment suitable for bonding to a metal atom; reacting the solid polymeric material to provide a modified solid polymeric material comprising a plurality of modified pendant groups, each modified pendant group having the first point of attachment and a second point of attachment that is suitable for bonding to a metal atom which second point is proximal to the first point of attachment; reacting the modified solid polymeric material with metal; and obtaining a product having metal bound to solid polymeric material at least the first and the second points of attachment of at least some of the modified pendant groups.

In an embodiment of the second aspect, the metal is palladium, platinum, nickel, iron, rhodium, yttrium, ruthenium, osmium, iridium, rhodium, titanium, zirconium, or gold.

In an embodiment of the second aspect, the product comprises metallocycles.

In another embodiment of the second aspect, a said pendant group comprises a functional moiety that is zero, one, two, three, four, five or six atoms from the main chain, wherein the functional moiety comprises the first point of attachment.

In a third aspect, the invention provides a method of preparing a heterogeneous catalyst comprising providing chloromethylated polystyrene comprising a main chain and a plurality of chlorobenzyl pendant groups, each pendant group having an ortho carbon; reacting the chloromethylated polystyrene to provide dimethylaminomethylene polystyrene comprising a plurality of dimethylaminobenzyl pendant groups, each having the ortho carbon and an amine nitrogen, which nitrogen is proximal to the ortho carbon; reacting the dimethylaminomethylene polystyrene with Pd(II); and obtaining a heterogeneous catalyst comprising Pd bound to polystyrene at least the ortho carbon and the amine nitrogen of two or more pendant groups.

In another aspect, the invention provides a method of preparing a heterogeneous catalyst comprising providing chloromethylated polystyrene comprising a main chain and a plurality of chlorobenzyl pendant groups, each pendant group having an ortho carbon; reacting the chloromethylated polystyrene to provide dimethylaminomethylene polystyrene comprising a plurality of dimethylaminobenzyl pendant groups, each having the ortho carbon and an amine nitrogen, which nitrogen is proximal to the ortho carbon; reacting the dimethylaminomethylene polystyrene with Pd(II); and obtaining a heterogeneous catalyst comprising Pd bound to polystyrene at least the ortho carbon and the amine nitrogen of one or more pendant groups.

In a fourth aspect, the invention provides a method of preparing a heterogeneous catalyst comprising providing chlorobenzyl functionalized silica comprising a main chain and a plurality of chlorobenzyl pendant groups, each pendant group having an ortho carbon; reacting the chlorobenzyl functionalized silica to provide dimethyl-aminobenzyl functionalized silica comprising a plurality of dimethylaminobenzyl pendant groups, each having the ortho carbon and an amine nitrogen, which nitrogen is proximal to the ortho carbon; reacting the dimethylaminobenzyl functionalized silica with Pd(II); and obtaining a heterogeneous catalyst comprising Pd bound to solid polymeric material at least the ortho carbon and the amine nitrogen of two or more dimethylaminobenzyl pendant groups.

In another aspect, the invention provides a method of preparing a heterogeneous catalyst comprising providing chlorobenzyl functionalized silica comprising a main chain and a plurality of chlorobenzyl pendant groups, each pendant group having an ortho carbon; reacting the chlorobenzyl functionalized silica to provide dimethyl-aminobenzyl functionalized silica comprising a plurality of dimethylaminobenzyl pendant groups, each having the ortho carbon and an amine nitrogen, which nitrogen is proximal to the ortho carbon; reacting the dimethylaminobenzyl functionalized silica with Pd(II); and obtaining a heterogeneous catalyst comprising Pd bound to solid polymeric material at least the ortho carbon and the amine nitrogen of one or more dimethylaminobenzyl pendant groups.

In a fifth aspect, the invention provides a method of immobilizing metal comprising providing a solid polymeric material comprising a main chain and a plurality of pendant groups, each pendant group having a first point of attachment suitable for bonding to a metal atom; reacting the solid polymeric material to provide modified solid polymeric material comprising a plurality of modified pendant groups, each pendant group having the first point of attachment and a second point of attachment suitable for bonding to a metal atom, which second point of attachment is proximal to the first point of attachment; reacting the modified, solid polymeric material with metal; and obtaining a product comprising metal bound to solid polymeric material at least the first and the second points of attachment of two or more modified pendant groups.

In another aspect, the invention provides a method of immobilizing metal comprising providing a solid polymeric-material comprising a main chain and a plurality of pendant groups, each pendant group having a first point of attachment suitable for bonding to a metal atom; reacting the solid polymeric material to provide modified solid polymeric material comprising a plurality of modified pendant groups, each pendant group having the first point of attachment and a second point of attachment suitable for bonding to a metal atom, which second point of attachment is proximal to the first point of attachment; reacting the modified solid polymeric material with metal; and obtaining a product comprising metal bound to solid polymeric material at least the first and the second points of attachment of one or more modified pendant groups.

In an embodiment of the fifth aspect, a said pendant group comprises a functional moiety comprising the first point of attachment that is zero or one atom from the main chain.

In a sixth aspect, the invention provides a heterogeneous catalyst prepared by the methods described herein. The heterogeneous catalyst may be chiral.

In a seventh aspect, the invention provides use of the heterogeneous catalyst of the fifth aspect to catalyze decomposition of a P═S phosphorothioate compound. The P═S phosphorothioate compound can be fenitrothion, dichlofenthion, coumaphos, diazinon, quinalphos, or malathion.

In embodiments of the aspects described above, the ortho carbon may be unsubstituted. In certain embodiments, the ortho carbon may be substituted with a halo substitutent.

In an eighth aspect, the invention provides a method of decomposing a P═S phosphorothioate compound comprising providing a heterogeneous catalyst as described in the sixth aspect; and contacting an appropriately buffered solution comprising alcohol and a P═S phosphorothioate starting material with the heterogeneous catalyst; wherein the P═S phosphorothioate starting material is at least partially decomposed.

In embodiments of the above aspects, the solid polymeric material comprises a plurality of monomeric repeating units, said monomeric repeating units having the first point of attachment.

Another aspect provides a heterogeneous catalyst comprising dimethylaminomethylene polystyrene and palladium or platinum.

Another aspect provides a kit for heterogeneous catalysis comprising a heterogeneous catalyst as described in the sixth aspect. In certain embodiments, the kit may include an appropriately buffered solution. In other embodiments, the kit may include instructions for use.

In another aspect, the invention provides an immobilized ortho palladacycle as shown below:

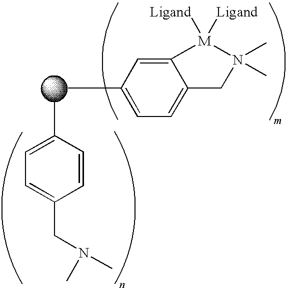

where

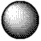

is a polymeric moiety that is covalently bonded to 4-benzyldimethylamine pendant groups; m is 1 to a large number; n is 0 to a large number; M is a metal atom; and Ligand is a moiety that transiently occupies valence positions on M that are available for reaction. In certain embodiments of this aspect, m is 2 to a large number. In some embodiments of this aspect, the polymeric moiety is silica. In other embodiments the polymeric moiety is polystyrene. In some embodiments of this aspect, M is Pd(II). In some embodiments of this aspect, Ligand is methoxide, methanol, ethoxide, ethanol, 1-propoxide, 1-propanol, 2-propoxide, 2-propanol, acetonitrile, THF, furan, or OTf.

In another aspect, the invention provides an immobilized ortho palladacycle as shown below:

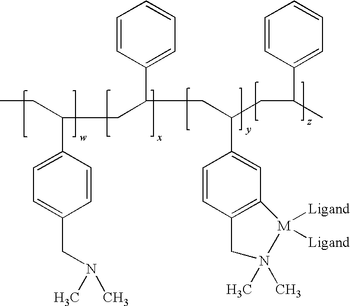

where w, x and z are independently 0 to a large number; y is 1 to a large number; M is a metal atom; and Ligand is a moiety that transiently occupies valence positions on M that are available for reaction. In certain embodiments of this aspect, y is 2 to a large number. In certain embodiments of this aspect, M is Pd(II). In some embodiments of this aspect, Ligand is methoxide, methanol, ethoxide, ethanol, 1-propoxide, 1-propanol, 2-propoxide, 2-propanol, THF, furan, or OTf.

Aspects of the invention provide heterogeneous catalysts that may be suitable for use in catalyzed organic reactions such as those commonly performed by pharmaceutical and agrochemical industries, as well as by manufacturers of fine chemicals, cosmetics, and flavourings.

### BRIEF DESCRIPTION OF THE DRAWINGS

For a better understanding of the invention and to show more clearly how it may be carried into effect, reference will now be made by way of example to the accompanying drawings, which illustrate aspects and features according to embodiments of the present invention, and in which:

FIG. 1A is a graph of Absorbance vs. Time for the disappearance of 2 (1×10⁻⁵ M) (▴, absorbance at 267 nm) catalyzed by 0.0455 g SiPd1 and for the appearance of 3-methyl-p-nitrophenol (▪, absorbance at 310 nm) at T=25° C., ₛ^{s}pH=8.8; the time scale has been corrected as discussed in Example 7.

FIG. 1B is a graph of Absorbance vs. Time for the disappearance of 2 (3×10⁻⁵ M) (▴, absorbance at 272 nm) catalyzed by 0.0426 g PSPd3 and for the appearance of 3-methyl-p-nitrophenol (▪, absorbance at 310 nm) at T=25° C., ₛ^{s}pH=8.8; the time scale has been corrected as discussed in Example 7. Points () and (∘) represent the absorbances at 272 nm and 310 nm, respectively, after the same catalyst was shaken with a 3×10⁻⁵ M solution of 2 continuously for 2 minutes at T=25° C., ₛ^{s}pH=8.8.

FIG. 2 is a graph that plots pseudo-first-order rate constants (k_{obs}) vs. weight of catalyst for the methanolysis of 2 (1×10⁻⁵ M) catalyzed by PSPd2 (▪) and SiPd1 (□) at ₛ^{s}pH=8.8, in N-iso-propylmorpholine buffer (6.6×10⁻³ M), T=25° C.

FIG. 3 is a graph that plots pseudo-first-order rate constants (k_{obs}) vs. run number for the methanolysis of 2 (1×10⁻⁵ M) catalyzed by PSPd2 (0.0558 g) and SiPd1 (0.0418 g) at ₛ^{s}pH=8.8 and T=25° C. Average k_{obs}(PSPd2)=1.79±0.26 min⁻¹. Average k_{obs}(SiPd1)=0.52 min⁻¹.

FIG. 4 is a schematic depicting the preparation of an immobilized ortho-palladacycle (7) starting with solid support with a plurality of pendant groups that are 4-chlorobenzyl moieties.

FIG. 5 shows structural formulae for the following several compounds, 1 is a P═S phosophorothioate when Y is OR (no matter whether X is O or S), 1 is a P═S thiophosphonate when Y is R (again, regardless of X); 2 is fenitrothion; 3 is (N,N-dimethylaminobenzyl-C¹,N)(pyridine)palladium(II) triflate; 4 is dichlorofenthion; 5 is coumaphos; 6 is diazinon; 8 is malathion; and 9 is malaoxon.

### DETAILED DESCRIPTION OF EMBODIMENTS OF THE INVENTION

### Definitions

As used herein, “aliphatic” includes alkyl, alkenyl and alkynyl. An aliphatic group may be substituted or unsubstituted. It may be straight chain, branched chain or cyclic.

As used herein “aryl” means aromatic. The term aryl includes heteroaryl and may be substituted or unsubstituted.

As used herein, the term “chain” means a continuously linked group of atoms.

As used herein, the term “catalytic species” means a molecule or molecules, comprising metal atoms, whose presence increases the rate of reaction of other species relative to their rate of reaction in the absence of the catalytic species.

As used herein, the term “appropriately buffered” means that the ₛ^{s}pH of a solution is controlled by adding non-inhibitory buffering agents.

As used herein, the term “ₛ^{s}pH” is used to indicate pH in a non-aqueous solution (Bosch, E.; Rived, F.; Roses, M.; Sales, J., J. Chem. Soc., Perkin Trans. 2, 1999, 9, 1953; Rived, F.; Rosés, M.; Bosch, E., Anal. Chim. Acta 1998, 374, 309; Bosch, E.; Bou, P.; Allemann, H.; Rosés, M. Anal. Chem. 1996, 68 (20), 3651). One skilled in the art will recognize that if a measuring electrode is calibrated with aqueous buffers and used to measure pH of an aqueous solution, the term _{w}^{w}pH is used. If the electrode is calibrated in water and the “pH” of a neat methanol solution is then measured, the term ₛ^{w}pH is used, and if the latter reading is made, and a correction factor of 2.24 (in the case of methanol) is added, then the term ₛ^{s}pH is used.

As used herein “unsubstituted” refers to any open valence of an atom being occupied by hydrogen.

As used herein “substituted” refers to the structure having one or more substituents. A substituent is an atom or group of bonded atoms that can be considered to have replaced one or more hydrogen atoms attached to a parent molecular entity. Possible substituents, include any atom or group that does not inhibit the desired reaction. Examples of substituents include aliphatic, halogen, hydroxyl, alkylcarbonyloxy, arylcarbonyloxy, alkoxycarbonyloxy, aryloxycarbonyloxy, carboxylate, alkylcarbonyl, alkoxycarbonyl, aminocarbonyl, alkylthiocarbonyl, alkoxyl, phosphate, phosphate ester, phosphonato, phosphinato, cyano, amino, acylamino, amide, imino, sulfhydryl, alkylthio, arylthio, thiocarboxylate, dithiocarboxylate, sulfate, sulfonato, sulfamoyl, sulfonamido, nitroso, nitro, nitrile, trifluoromethyl, azido, heterocyclyl, aromatic, and heteroaromatic moieties, ether, epoxide, ester, anhydride, boron-containing moieties, and silicon-containing moieties.

As used herein the term “solid polymeric material” generally refers to a macromolecule made by covalent bonding of identical small units that is a solid at the temperature and pressure at which it will be used. It may also be a semi-solid or gel that is readily separated from a solution. It may be purchased from a commercial supplier (usually in bulk quantities at a reasonable cost, for example, polystyrene, silica gel, etc.) or can be made by processes known in the art.

As used herein the term “modified solid polymeric material” means a solid polymeric material that has been changed or modified by a chemical transformation reaction.

As used herein, the term “proximal” in general terms refers to a relatively close position. When used to refer to the distance between a first and a second point of attachment for a metal atom, proximal is intended to refer to 1 to 4 bonds apart so that when the metal atom is attached to the first and second points of attachment to form, a metallocycle, the metallocycle itself has five or six ring-atoms.

As used herein, the term “P═S” means a phosphorus doubly bonded to a sulfur.

As used herein, the term “P═S phosphorothioate” refers to a phosphorothioate compound that has a phosphorus doubly bonded to a sufur. In general terms, the term phosphorothioate infers that a phosphorus and a sufur are in the compound, but no information is provided regarding their relative positions in the compound. The term “P═S phosphorothioate” is thus intended to be more specific in regard to the relative positions of these atoms in a compound.

As used herein, the term “decomposing a P═S phosphorothioate compound” refers to rendering a deleterious P═S phosphorothioate compound that has a phosphorus doubly bonded to a sufur into a less toxic or non-toxic form.

As used herein, the term “non-inhibitory agent or compound” means that the agent or compound does not substantially diminish the rate of a reaction, which may or may not be a catalyzed reaction, when compared to the rate of the reaction in the absence of said agent or compound.

As used herein, the term “inhibitory agent or compound” means that the agent or compound does substantially diminish the rate of a reaction, which may or may not be a catalyzed reaction, when compared to the rate of the reaction in the absence of said agent or compound.

As used herein the term “coordinate bond,” also known as a “dative bond,” means a covalent bond in which both shared electrons are furnished by the same atom.

As used herein the term “covalent bond” means a chemical bond formed by the sharing of one (or more) electron pairs between two atoms.

As used herein the term “carbon-metal bond” means a bond between a carbon atom and a metal atom. It is a relatively stable bond since it has sigma bonding character. Such bonds are less apt to dissociate and associate than coordinate bonds.

As used herein the term “cyclopalladated” refers to a molecule with palladium as part of a ring, which may be a fused ring system.

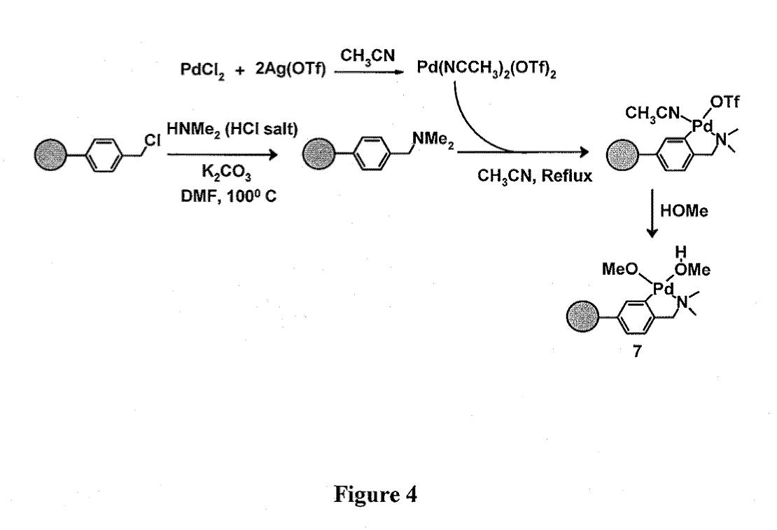

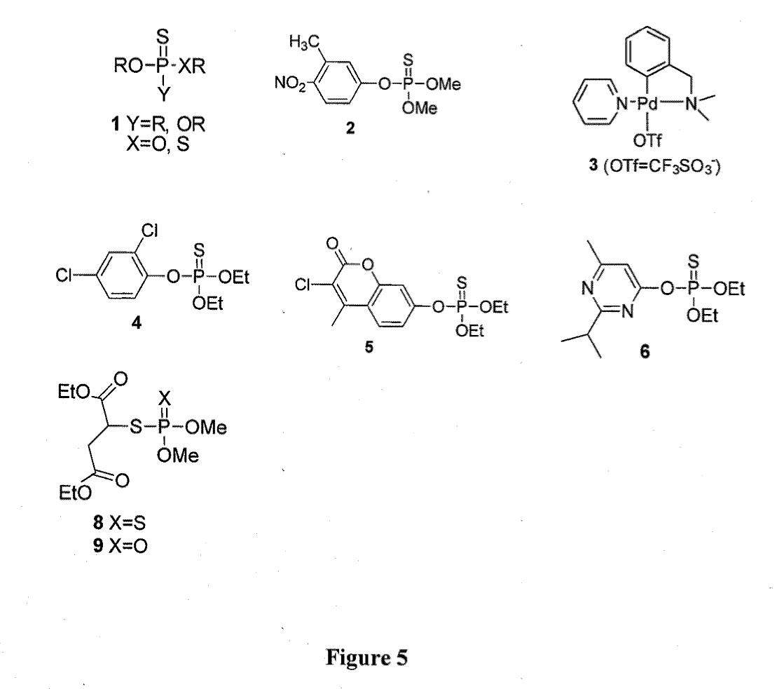

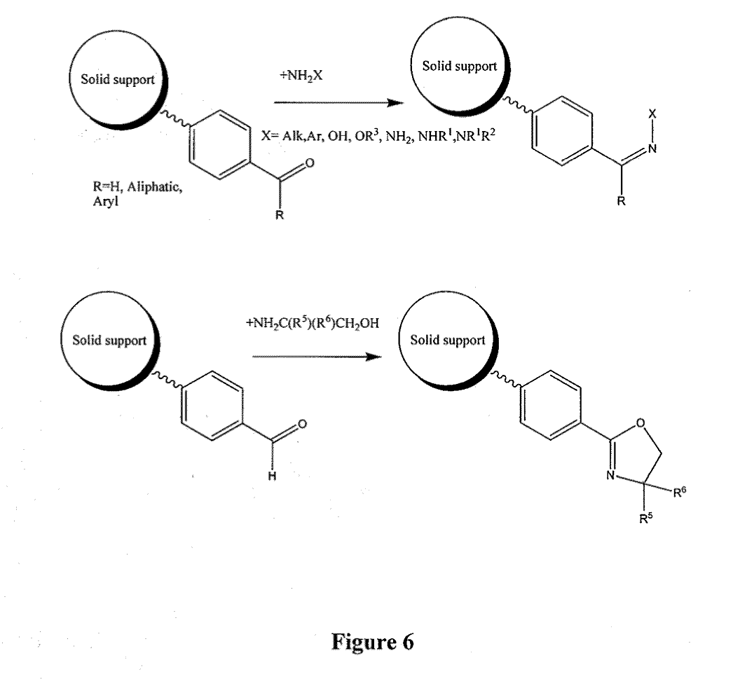

As used herein the term “1” means a P═S phosophorothioate as shown in FIG. 5. As used herein the term “2” means fenitrothion, which is O,O-dimethyl O-(3-methyl-4-nitrophenyl) phosphorothioate (see structural formulae for compounds 2-6, 8 and 9 in FIG. 5). The term “3” means (N,N-dimethylaminobenzyl-C¹,N)(pyridine)-palladium(II) triflate. The term “4” means dichlorofenthion, which is O,O-diethyl O-(2,4-dichlorophenyl) phosphorothioate. The term “5” means coumaphos, which is 0-(3-chloro-4-methyl-2-oxo-2H-chromen-7-yl) O,O-diethyl phosphorothioate. The term “6” means diazinon, which is O,O-diethyl O-(2-isopropyl-4-methyl-6-pyrimidinyl) phosphorothioate. The term “7” is used to represent an immobilized ortho-palladacycle that is depicted in FIG. 4. The term “8” means malathion, which is O,O-dimethyl-S-(1,2-dicarbethoxy)ethyl phosphorodithioate. The term “9” means malaoxon, which is O,O-dimethyl-S-(1,2-dicarbethoxy)ethyl phosphorothioate. The term “quinalphos” refers to (O,O-diethyl O-(2-quinoxalyl) phosphorothioate (see Org. Biomol. Chem. 2005, 3, 3379).

For convenience herein, portions of solid polymeric materials have been designated as “SS” and “LL”. “SS” refers to a main chain portion that is a long continuously-linked portion of the polymer that may be branched or unbranched. “LL” is also known as a “pendant group” and is a side chain of atoms that are attached to the main chain of the polymer. There are a plurality of pendant groups on the solid polymeric material. The LL may or may not be part of the monomeric repeating unit from which the polymer was made. An example of the LL being part of the repeating unit is polystyrene. In polystyrene there is a carbon chain that is the main chain and phenyl groups that are the pendant groups. In polystyrene, since the phenyl groups are part of the styrene monomer they are part of the repearting unit in polystyrene, but the phenyl groups are not part of the main chain. An example of LL not being part of the repeating unit that makes up the polymer is a functionalized silica gel. In it, the main chain is made and then it is functionalized with pendant groups. Accordingly, plurality of pendant groups are attached to the [SiO₂]ₙ main chain in a random pattern. The pendant groups are attached to the SiO₂ but they are not part of the repeating unit.

For clarity, an example of a particular solid polymeric material with its SS and LL portions labelled, is pictured below. It is chloromethylated polystyrene, which has an SS portion comprising a hydrocarbon chain, and it has a plurality of LL portions comprising chlorobenzyl side chains and phenyl side chains (n is independently zero to a very large number since polymers may have large numbers of monomeric repeating units).

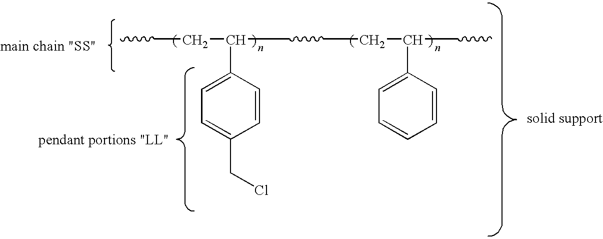

In another example of a particular solid polymeric material with SS and LL portions is a functionalized silica gel with a benzyl chloride pendant group, wherein the SS portion is repeating units of SiO₂ and the LL pendant portions are chlorobenzyl groups.

As used herein, the term “SS-LL>M” means a solid support, SS-LL, that is bound to a metal atom through two points of attachment on the LL.

As used herein, the term “PSPd” means an embodiment of SS-LL>M comprising polystyrene (PS) with side chains that are dimethylbenzylamine groups, and a metal ion that is palladium.

As used herein, the term “SiPd” means an embodiment of SS-LL>M comprising silica with side chains that are dimethylbenzylamine groups, and a metal atom that is palladium.

As used herein the term “metal” means metal atoms that may or may not be metal ions. Metal atoms may act as catalysts in a variety of oxidation states. For example, some metal atoms may be catalytically active and form complexes in their zero oxidation state. During some catalysis, reactions a metal's, oxidation state may change.

### DESCRIPTION OF EMBODIMENTS

Solid polymeric material generally refers to insoluble or unsolubilized under the conditions of use, functionalized, polymeric material to which reagents may be attached often via side chains or linkers allowing them to be readily separated (by filtration, centrifugation, decantation, etc.) from excess reagents, soluble reaction by-products, or solvents. It is useful to attach a catalyst to a solid polymeric material to produce solid catalyst since the solid catalyst can then be easily removed and recovered by, for example, filtration, decantation, centrifugation. Such recovery reduces cost since it prevents loss of expensive catalyst and eliminates the need for removal of metals from waste materials. Solid catalysts facilitate reactions since they can be used, for example, in a column wherein a reactant solution is catalytically converted while the solution passes through the column. Thus solid bound catalysts are desirable since they facilitate reactions and reduce cost.

In certain immobilized palladium compounds (e.g., compounds 27 and 28 of Bergbreiter, D. E. Chem. Rev. 2002, 102, 3345), polymer is bound to azo side chains that bind to palladium in a bidentate manner. These compounds were synthesized using a series of reactions and do not use readily available starting material. Their syntheses are neither simple, nor inexpensive, nor-concise in number of steps. Their product has two attachment-points between the metal and the polymer side chain; however, neither of the two attachment points was present in the polymeric starting material. Rather, the side chain was introduced to the polymer and built using a series of complicated synthetic steps. These compounds are not available by way of a method as simple as is described herein.

By contrast, aspects of the invention use solid polymeric materials that may be readily available in bulk from commercial manufacturers, including such inexpensive starting materials as, for example, macroporous halomethylated polystyrene and benzylhalo-functionalized silica gel. An advantage of this method is that one of the at least two attachment points, which bind the solid polymeric material to the metal in the end product, is already present in the solid polymeric starting material. After a simple reaction, a second attachment point is added that is proximal to the first point of attachment. Finally, a metal is reacted and binds at the first and the second attachment points to form the heterogeneous catalyst. By using readily available, inexpensive starting materials and only a small number of synthetic steps, methods of the invention provide an inexpensive way to obtain immobilized metal and form heterogeneous metal catalysts.

Any metal that is catalytically active can be bound to a solid polymeric material using methods of the invention. Such metals may include, for example, palladium, platinum, nickel, iron, rhodium, yttrium, ruthenium, osmium, iridium, rhodium, titanium, zirconium, gold, etc. Non-limiting examples are described herein using palladium.

A simple and cost-effective method of covalently attaching a solid polymeric material to metal is described herein. By anchoring metal atoms on a solid support via a metallocycle, a proficient, reusable, and cost effective heterogeneous catalyst is provided.

The product of this method, known herein as SS-LL>M, is a compound that has a metal atom bound to a solid support moiety. Specifically, in the product the metal, M, is bound to the solid polymeric material, SS-LL, through at least two-points of attachment on the pendant group, LL.

In one aspect, the invention modifies a solid polymeric material, which has a first point of attachment suitable for bonding to a metal atom located on a side chain, to create a second point of attachment suitable for bonding to a metal atom that is also on the side chain and that is proximal to the first point of attachment. Then when the solid polymeric material has two points of attachment suitable for bonding to a metal atom, a solubilized form of metal is reacted with it such that metal atom becomes bound to the solid polymeric support at the two points of attachment.

In some embodiments, the LL side chain portion is bound to the SS main chain portion with zero atoms between SS and a functional moiety on LL that bears the first point of attachment. In other embodiments, the LL side chain portion is bound to the SS main chain portion with one atom between SS and a functional moiety on LL. In other embodiments, the LL side chain portion is bound to the SS main chain portion with two atoms between SS and a functional moiety on LL. In other embodiments, the LL side chain portion is bound to the SS main chain portion with three atoms between SS and a functional moiety on LL. In other embodiments, the LL side chain portion is bound to the SS main chain portion with four atoms between SS and a functional moiety on LL. In other embodiments, the LL side chain portion is bound to the SS main chain portion with five atoms between SS and a functional moiety on LL. In other embodiments, the LL side chain portion is bound to the SS main chain portion with six atoms between SS and a functional moiety on LL. Examples of functional moieties include reactive species, for example, substituted or unsubstituted aryl including phenyl and pyridyl.

Notably, the first point of attachment was present on the pendant group of the solid polymeric starting material. In certain embodiments, the pendant group having the first point of attachment was present in the monomeric repeating unit from which the solid polymeric material was originally made. In other embodiments, the pendant group having the first point of attachment was not present in the monomeric repeating unit from which the solid polymeric material was made. In many embodiments described herein the first point of attachment is a carbon atom. However, in certain embodiments of the invention the first point of attachment is a heteroatom. The solid polymeric starting material was reacted to produce a modified solid polymeric material with a modified pendant group having the first point of attachment and a second point of attachment suitable for bonding to a metal atom. The second point of attachment is proximal to the first point of attachment. When the second point of attachment is close to the first point of attachment both points of attachment can bond to the same metal atom. The proximity between the two points of attachment determines the geometry of the ring that they form with the metal in the product. When the first and second points of attachment are three or four bonds away from one another, a metallocycle forms that is a five-, or six-membered ring, respectively. In general terms, rings with five or six members are relatively stable moieties. Five or six membered rings are particularly suited here since they offer bond angles that allow the metal to have square planar or near square planar geometry.

In certain embodiments of the invention where LL is a benzylamine moiety, the five membered ring is made up of the following atoms: Pd(II); ortho ring-carbon; methylene-substituted phenyl-ring carbon; benzylic carbon; and amine nitrogen. This particular five-membered ring enables Pd(II) to have a stable square planar or near square planar geometry.

In some embodiments of the invention, the second point of attachment is a heteroatom, such as, for example, nitrogen, oxygen, sulfur, selenium, phosphorus, or arsenic. As discussed above in some embodiments, the first point of attachment is a carbon atom. Without wishing to be bound by theory, the inventors consider that in embodiments where the points of attachment being a carbon and a heteroatom, the heteroatom binds to the metal ion prior to the carbon atom binding to the metal ion. Once a dative bond forms between the metal and the heteroatom, the metal is held proximal to the ortho carbon. This close proximity promotes formation of a relatively stable metal-carbon bond. So, in embodiments where LL is dimethylbenzylamine, because the bond between the metal atom and the amine nitrogen is a coordinate bond and the bond between the metal atom and the ortho phenyl ring-carbon is a carbon-metal bond, the product SS-LL>M is quite stable.

In some embodiments of the invention, the second point of attachment is a carbon atom that is a carbanion.

In some embodiments, the carbon that is the first attachment point is present in the solid polymeric starting material, and the heteroatom that is the second attachment point is introduced in the modification step.

In embodiments where LL is dimethylbenzylamine, SS-LL>M is stabilized also by the bidentate relationship between the metal atom and the dimethylbenzylamine LL.

In certain embodiments of the invention, the metal atoms are palladium(II) or platinum(II), which are stable in a square planar or near square planar configuration. Thus, by satisfying the bond angle requirements of a square planar configuration, the two attachment points on LL form a stable geometry around the metal. By occupying two valence positions in the square planar metal complex, there are two other positions around the metal that are available for catalytic activity.

Catalytic activity was investigated for certain embodiments of SS-LL>M and is summarized herein. Since palladium and platinum are capable of catalyzing a multitude of chemical transformation reactions, it was necessary to select a particular catalytic reaction for study to quantify the effectiveness of the immobilized catalysts. The particular catalytic reaction that was selected for detailed study was the catalysis of the methanolysis of P═S phosphorothioate triester pesticides. However, this choice is not intended to be limiting. In addition to catalyzing the decomposition of pesticides, immobilized metal catalysts of the invention may be suitable for use in such chemical reactions as, for example: coupling reactions (e.g., Heck reaction, Suzuki reaction, Kumada reaction, Stifle reaction, Sonogashira coupling, Negishi coupling, Buchwald-Hartwig amination, and Hiyama reaction); hydrosilylation; hydrogenation; and debenzylation. Among palladium catalysts, palladacycles are frequently used in catalytic transformations including: proximally directed arylation reactions and intramolecular cross-coupling reactions.

Although there are many solid supports that are suitable for the invention, two particular ones were selected for in-depth study; these were macroporous polystyrene and silica. Chloromethylated polystyrene and 4-benzyl chloride functionalized silica gels were chosen as solid supports based on their commercial availability and previous success in functionalizing various polystyrene based materials (Didier, B.; Mohamed, M. F.; Csaszar, E.; Colizza, K. G., Neverov, A. A.; Brown, R. S. Can. J. Chem. 2008, 86, 1). Chloromethylated polystyrene, as a support matrix offers chemical inertness, hydrophobicity, and structural stability (Chauvin, Y.; Commereuc, D.; Dawans, F. Prog. Polym. Sci. 1977, 5, 95). Silica gel as a support matrix offers large surface area, which is accessible to solvent, and hydrophilicity. Hydrophilicity may be of advantage in embodiments of the invention involving water and polar molecules since they would be able to favourably intereact with the active complex (Corma, A; Garcia, H Topics in Catalysis 2008, 48, 8-31).

SS-LL>M compounds comprising palladium and macroporous polystyrene are known herein as “PSPd”. Three batches of PSPd were prepared and their catalytic ability was investigated; they are denoted PSPd1, PSPd2, and PSPd3. The amount of palladium differs between these three batches and is described in Table 1. The source of palladium used to prepare PSPd1 differs from the source used for both PSPd2 and PSPd3. The source of palladium for the preparation of PSPd1 was Li₂PdCl₄. The source of palladium for the preparations of PSPd2 and PSPd3 was PdCl₂.

SS-LL>M compounds comprising palladium and amorphous silica gel are known herein as “SiPd”. Three batches of SiPd were prepared and their catalytic ability was investigated; they are denoted SiPd1, SiPd2 and SiPd3. The amount of palladium differs between batches and is described for each in Table 1. Preparation of SiPd is described in Examples 3A-C and 4. Each of SiPd1, SiPd2 and SiPd3 had PdCl₂ as the source of palladium.

In certain embodiments of the invention, LL was dimethylbenzylamine (see FIG. 4). As one of ordinary skill in the art will recognize, dimethylbenzylamine is a molecule with a phenyl ring with a single benzylic carbon with a dimethylamine substitutent. Thus the positions of the phenyl-ring atoms are known as ortho, meta and para relative to the ring atom that bears the benzylic carbon substituent.

In these embodiments, the solid support was covalently bonded to LL at its para ring-carbon. Palladium was covalently bonded to LL through two attachment points. These attachment points were the benzylamine nitrogen and the ortho phenyl-ring carbon (see FIG. 4).

It is noted that for embodiments of the invention, the first point of attachment that was present in the starting material of the synthesis, was the ortho phenyl-ring carbon that has a carbon-metal bond to the Pd(II) in the product (see FIG. 4). The starting material for PSPd embodiments was macroporous chloromethylated polystyrene; the starting material for SiPd embodiments was 4-benzyl chloride functionalized silica gel. Both of these starting materials have the ortho-carbons present.

In embodiments where LL is benzylamine, the amine nitrogen has two substituents that are not bound to the palladium nor the benzylic carbon (NR₂). In certain embodiments, these substituents are methyl groups, i.e., dimethylbenzylamine. However, NH₂, NHR, and NR₂ are also possible where R is a substituted or unsubstituted aliphatic or aryl moiety. Chiral embodiments will be described further below; however, it is noted that in this particular embodiment where LL is benzylamine, a chiral R group on the nitrogen may make the product heterogeneous catalyst chiral. Likewise, when the benzylic carbon has different substituents, the product has a chiral center.

Both polymer and silica based catalysts of palladium and dimethylbenzylamine were prepared. Brief descriptions of their syntheses will now be provided. For more details in regard to these syntheses see the Working Examples. Referring now to FIG. 4, a schematic diagram is shown depicting a scheme for preparation of heterogeneous catalysts. On the left side of FIG. 4, a generic solid support bead (e.g., polystyrene, silica) with 4-benzyl chloride pendant groups is pictured (for clarity only one of the many pendant groups is shown). In the first and leftmost reaction, nucleophilic substitution of the chloride by dimethylamine gave modified solid polymeric material via reaction of the substitutent with dimethylamine hydrochloride and potassium carbonate in anhydrous dimethylformamide (DMF) at 100° C. The product of this leftmost reaction is a N,N-dimethylbenzylamine solid support which was isolated and dried. In a separate flask and represented in the topmost reaction, palladium chloride, which is sparingly soluble in acetonitrile, is converted to the more soluble form bistriflate bisacetonitrile palladium by the addition of two equivalents of silver triflate to anhydrous acetonitrile (CH₃CN). Although PdCl₂ may be suitable for use in place of bistriflate bisacetonitrile palladium, it also may form chloride dimers and other side products. Removal of chloride by precipitation in the form of AgCl, prevents formation of such side products. Bistriflate bisacetonitrile palladium, the product of the topmost reaction, Pd(CH₃CN)₂(OTf)₂, (OTf is -0₃SCF₃) in acetonitrile was added to anchored. N,N-dimethylbenzylamine (product' of leftmost reaction) and the two phase mixture was heated to reflux in acetonitrile. The filtered product, as shown in the upper right side of FIG. 4, was then washed with methanol to displace acetonitrile and possibly triflate from the available valence positions on palladium to give the catalytically active species 7 (as depicted at bottom right of FIG. 4). It will be recognized by those skilled in the art of the invention that although 7 is depicted in FIG. 4 as having its available valence positions occupied by a methoxide and a methanol, other ligand species would also be suitable. Suitable ligands are those that transiently occupy such valence positions and thus are displaceable under reaction conditions. Non-limiting examples of such ligands include solvent (e.g., acetonitrile, methanol, ethanol, 1-propanol, 2-propanol, THF, furan) or other displaceable ligands (e.g., methoxide, ethoxide, 1-propoxide, 2-propoxide, OTf).

A simple method to generate a catalyst immobilized on solid supports has been described. Investigations showed that some of these immobilized catalysts have excellent catalytic activity and robustness. Their catalytic activity was studied using a reaction that is well known to the inventors (see U.S. Pat. No. 7,214,836 of Brown et al.), namely, the methanolysis of P═S phosphorothioate triesters 2 and 4-6 at ambient temperature and at near neutral ₛ^{s}pH. (Compounds 2, 4, 5, 6, and 8 are all commercially available pesticides whose chemical structures have a P═S moiety; their chemical structures are depicted in FIG. 5.)

As described above, three batches of SiPd were prepared for catalysis studies described herein. The amount of palladium in each batch was determined by inductively coupled plasma—optical emission spectroscopy, while the N content was determined by microanalyses (see Table 1). As shown in Table 2, the silica-dimethylbenzylamine-palladium complex offered accelerations of up to 8.6×10⁹-fold for the methanolysis of 2 when compared to its uncatalyzed background methoxide reaction at ₛ^{s}pH=8.8.

As described above, three batches of PSPd were prepared for catalysis studies, i.e., PSPd1, PSPd2, and PSPd3 (see preparation in Examples 1 and 2). The amount of palladium in each batch was determined by inductively coupled plasma—optical emission spectroscopy, while the N content was determined by microanalyses (see Table 1). As shown in Table 2. the polystyrene-dimethylbenzylamine-palladium complex offered accelerations of up to 3.7×10⁹-fold of the methanolysis of 2 when compared to its uncatalyzed background methoxide reaction at ₛ^{s}pH=8.8. The silica-based material is believed to have most of its active sites at the surface and thus accessible to the reaction solvent, as well as a greater hydrophilicity of its surface compared to the polymer based catalyst. Unlike the behavior in homogeneous solution, the rate of methanolysis of the substrates catalyzed by the solid catalysts was relatively insensitive to the nature of the substrate indicating that a mass transport process involving surface and diffusion effects may be rate limiting.

As discussed above, palladium content of each of the solid materials as determined by atomic absorption spectroscopy and nitrogen content as determined by microanalysis were analyzed and are provided in Table 1. In comparison to the chloride content of commercial chloromethylated polystyrene, the palladium content represented a maximum of 10-20% conversion of original chloromethyl groups on polystyrene to palladacycle complex. However, nitrogen content was higher, at 55% of stated Cl in the commercial polystyrene. The stated chloride loading of the commercial polystyrene (2.8 mmol/g) represents the total chloride content and not the content of chloride accessible to solvent, so it is possible that a considerable fraction of the total chloride content may be buried deep inside the polymer matrix where it is inaccessible to the substitution or palladation reactions. The reduced conversion of the Cl to final Pd complexes seen here may also be the result of a far slower reaction for palladation due to the decreased reactivity of functional groups on rigid, highly cross-linked polymeric backbones (Guyot, A. Pure Appl. Chem. 1988, 60, 365). The analyzed loadings observed in these studies are comparable to those previously reported (Baleizão, C.; Corma, A.; Garcia, H.; Leyva, A. J. Org. Chem. 2004, 69, 439) for grafting of oxime carbapalladacycle on polystyrene.

Three versions of silica supported catalyst from dimethylamine hydrochloride and K₂CO₃ were prepared where the palladium loading represented between 3% and 17% conversion of the reported 1.2 mmol/g chloromethylated starting material. When corrected for total amount of analyzed Pd, the three SiPd materials had activities within a factor of seven for the catalyzed methanolysis of a common substrate fenitrothion (2).

Both PSPd and SiPd showed excellent catalytic activity in near neutral methanol (ₛ^{s}pH=8.38) at ambient temperature. They were both shown to be truly heterogeneous catalysts that can be readily recovered and re-used without significant loss of activity.

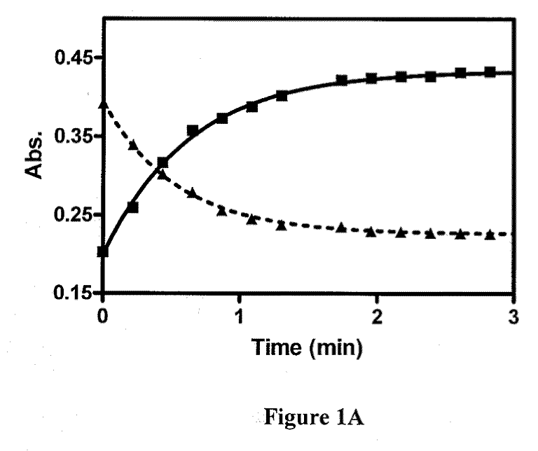

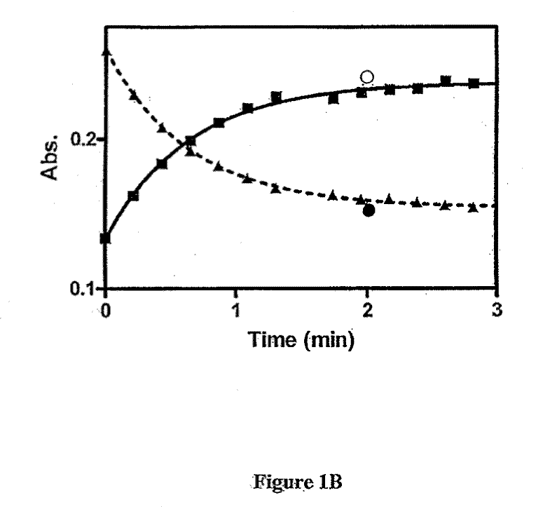

Referring to FIGS. 1A and 1B, evidence of the catalytic activities of SiPd1 and PSPd3 are presented as graphs of Absorbance vs. Time for the disappearance of 2. Analogously, a trace of the appearance of 3-methyl-p-nitrophenol is also shown. Table 3 shows first-order and apparent second-order rate constants for the methanolysis of P═S phosphorothioate triesters catalyzed by each of the silica-gel bound palladacycle (SiPd1, SiPd2 and SiPd3) in methanol at 25° C. and buffered at ₛ^{s}pH=8.8 by N-iso-propylmorpholine (6.6×10⁻³ M).

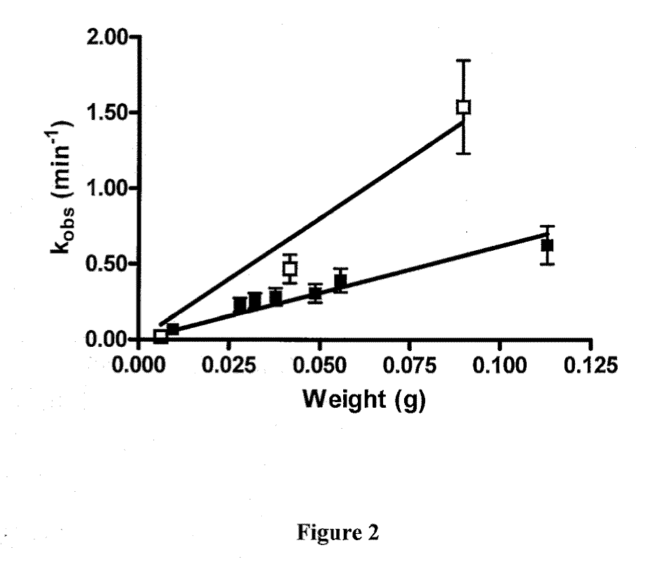

Referring to FIG. 2, evidence of the catalytic activity of polystyrene based palladium is graphically presented. FIG. 2 shows a plot of pseudo-first-order rate constants (kobs) vs. weight of catalyst for the methanolysis of 2 catalyzed by PSPd2 and SiPd1 at 25° C. and at =8.8 in N-iso-propylmorpholine buffer. Table 2 shows first-order and apparent second-order rate constants for the methanolysis of P═S phosphorothioate triesters catalyzed by polystyrene-bound palladacycle (PSPd2) in methanol at 25° C. and buffered at =8.8 by N-iso-propylmorpholine.

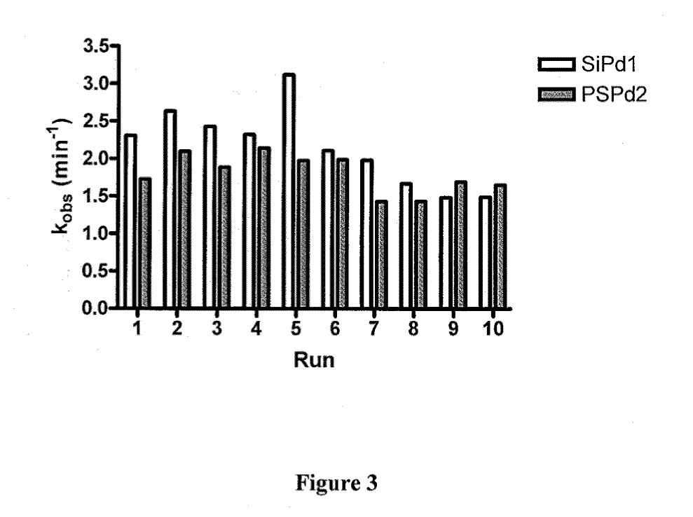

Referring to FIG. 3, evidence of the catalytic activity of polystyrene and silica based palladium for repeated reactions is presented. FIG. 3 plots pseudo-first-order rate constants (k_{obs}) vs. run number for the methanolysis of 2 (1×10⁻⁵ M) catalyzed by PSPd2 (0.0558 g) and SiPd1 (0.0418 g) at ₛ^{s}pH=8.8 and at 25° C.; average k_{obs}(PSPd2)=01.79±0.26 min⁻¹; average k_{obs}(SiPd1)=2.16±0.52 min⁻¹. Referring to FIG. 4, a schematic diagram that was discussed previously shows the preparation of an immobilized palladacycle (7) starting with solid support-bound benzyl chloride.

Referring to FIG. 5, structural formulae are shown for the following compounds that are discussed herein, 1 is a P═S phosophorothioate when Y is OR (regardless of X), 1 is a P═S thiophosphonate when Y is R (regardless of X); 2 is fenitrothion; 3 is (N,N-dimethylaminobenzyl-C¹,N)(pyridine)palladium(II) triflate; 4 is dichlorofenthion; 5 is coumaphos; 6 is diazinon; 8 is malathion; and 9 is malaoxon.

Referring to FIG. 6, a schematic depicts embodiments of the invention wherein chiral SS-LL>M catalysts are provided. A chiral heterogeneous catalyst may be useful as a reaction catalyst lithe reaction for which it is used involves the generation of chiral products. For example, it may be desirable to preferentially catalyze transformation of one stereoisomer in the presence of other stereoisomers. This schematic shows two synthetic schemes to form chiral modified solid polymeric materials (for metallation to form heterogeneous catalysts). The top scheme starts with a SS-LL with phenyl pendant groups with a C(O)R substituent, where R is H, aliphatic or aryl. Such solid polymeric materials are available from commercial sources or can be synthesized by direct formylation of polystyrene or silica (see U.S. Pat. No. 3,594,333; and Grigor'ev, V. V.; Dovnarovich, N. A.; Letashkov, A. V.; Ptashnikov, Yu. L.; Sagaidak, D. I. “Study of the formylation of polystyrene”, Nauchno-Issled. Inst. Prikl. Fiz. Probl. im. Sevchenko, Minsk, USSR. Vysokomolekulyarnye Soedineniya, Seriya B: Kratkie Soobshcheniya (1987), 29(1), 19-21). This reactant solid polymeric material is then reacted to form a modified solid polymeric material with a pendant group that has a nitrogen in place of the oxygen of the carbonyl group (see top right of FIG. 6). Notably, such embodiments can be chiral or achiral. To have a chiral system in this modified solid polymeric material, at least one of X or R must have a chiral center. For example, if any one of R, R¹ and R² has a chiral center then the product heterogeneous catalyst will be a chiral species. In the second reaction scheme of FIG. 6, to obtain a chiral SS-LL, either R⁵ and/or R⁶ can have a chiral centre, or R⁵ can be different than R⁶ in which case they would be bonded to a chiral centre.

In conclusion, embodiments of the invention showed that derivatization and palladation of commercially available chloromethylated polystyrene and 4-benzylchloride functionalized silica gels provides efficient heterogeneous catalysts. Catalysis was studied and results are described herein for the methanolysis of P═S phosphorothioate triesters where the departing group does not contain a free thiolate. The materials both show good catalytic activity towards the methanolysis of fenitrothion (2), dichlofenthion (4), coumaphos (5), and diazinon (6), all of which are commercially available P═S pesticides. The catalytic activity is shown to be somewhat greater for catalyst immobilized on silica gel relative to catalyst immobilized on polystyrene, probably due to the concentration of accessible reactive sites on the surface of the silica particles in comparison to the polystyrene beads or to the silica particles' hydrophilic surface, which allows better association of the solvent methanol with the attached catalyst than is the case with the polystyrene based catalysts. In the best case of the preliminary results described herein, 50 mg of the palladacycle immobilized on silica gel accelerates the methanolysis of 2 by a factor of 8.6×10⁹-fold compared to the background reaction at ₛ^{s}pH=8.8. However, this result was obtained only when the heterogeneous catalyst was in excess of the substrate. In cases where the substrate was in excess to the catalyst, there was a small, but noticeable drop in activity for reasons that are not clear but might be related to surface transport phenomena. Both the polystyrene and silica gel based catalysts showed good stability over the course of several sequential reactions and showed no product inhibition with substrate 2. It is noted that PSPd and SiPd were effective promoters of the methanolysis of malathion (8); however, catalyst turnover was inhibited by a product of the reaction. Without wishing to be bound by theory, the inventors suggest that thiolate anion acts as an inhibitor. It may be possible to employ oxidizing agents to convert thiolate anion into non-inhibiting disulfides or S═O compounds.

The following examples further illustrate the present invention and are not intended to be limiting in any respect.

### WORKING EXAMPLES

### Materials

Methanol (99.8% anhydrous), sodium methoxide (0.5 M solution in methanol), DMF (99.8%, anhydrous), K₂CO₃, Ag(OTf), PdCl₂, dimethylamine hydrochloride, dimethylamine (2.0M solution in THF), and 4-benzyl chloride functionalized silica gel (200-400 mesh, 1.2 mmolCl/g) were purchased from Sigma-Aldrich (Oakville, Ontario, Canada) and were used as supplied. Acetonitrile was purchased from Fisher Scientific (Ottawa, ON, Canada). Macroporous chloromethylated polystyrene resin (>12% of cross linking with DVB, 2.8 mmolCl/g, porosity size 100 Å, particle size 150-300 μm) was purchased from Polymer Laboratories (Amherst, Mass., USA). Fenitrothion (2), dichlofenthion (4), coumaphos (5), diazinon (6), and malathion (8) were purchased from Chem Service Inc. (West Chester, Pa., USA) and were used as supplied.

Polystyrene based catalyst (PSPd) and silica based catalyst (SiPd) were prepared by the same general methodologies. These methods started with halo-functionalized solid supports, specifically, macroporous chloromethylated polystyrene and 4-benzyl chloride functionalized silica gel. These halogenated solid supports were then reacted to form dimethylbenzylamine-functionalized solid supports, which were then palladated to form heterogeneous palladacycles.

### Example 1

### Preparation of Dimethylbenzylamine-Functionalized Polystyrene from Macroporous Chloromethylated Polystyrene

To a 2-necked round bottom flask was added 0.234 g (2.87 mmol) of dimethylamine hydrochloride and a small magnetic stir bar. The solid was dissolved in 20 mL of anhydrous DMF and 0.602 g (4.36 mmol) of K₂CO₃ was added to the solution. The solid carbonate remained largely undissolved at the bottom of the flask, and the mixture was allowed to stir at room temperature for two hours. At that point, 0.489 g of macroporous chloromethylated polystyrene (1.37 mmol Cl) was added to the reaction mixture along with an additional 0.19 g (1.37 mmol) K₂CO₃. The reaction flask was equipped with a reflux condenser and thermometer. The mixture was heated to 100° C. in an oil bath for four days while stirring gently to avoid crushing the polymer resin. Resultant polymer was filtered and washed first with excess water to dissolve all residual K₂CO₃ and then with 100 mL of methanol. The resultant polymer was pale yellow. It was immersed in a solution of 0.1 M sodium methoxide in methanol overnight to remove traces of acid and cap any residual chloromethyl functionality. Product dimethylbenzylamine-functionalized polystyrene polymer was filtered, washed with methanol (100 mL) and dried in an oven at 60° C. for 24 hours. See the first reaction of FIG. 4 for a schematic of this synthesis.

### Example 2

### Palladation of Dimethylbenzylamine-Functionalized Polystyrene

Red solid PdCl₂ (0.11 g, 0.64 mmol) and anhydrous acetonitrile (20 mL) were added to a Teflon® centrifuge tube. The solid was only sparingly soluble. To the mixture was added silver triflate salt (“Ag(OTf)”) (0.33 g, 1.3 mmol, 2 eq.). Immediately, formation of a thick beige precipitate (AgCl₍ₛ₎) was observed. A magnetic stir bar was added to the tube and the mixture was stirred vigorously for two hours until all of the red solid PdCl₂ was consumed. The thick beige precipitate was separated by centrifugation from a yellow supernatant. The supernatant was transferred to a 50 mL round bottom flask containing dimethylamine functionalized polystyrene (0.22 g) (see preparation above). Almost immediately after addition of the palladium solution, the pale yellow dimethylamine functionalized polystyrene resin began to darken. The reaction flask was equipped with a small magnetic stir bar and a reflux condenser and the two-phase mixture was heated at reflux for 24 hours. After cooling, a black polymer was isolated by filtration and was washed with 100 mL of methanol, and dried at 60° C. for 24 hours. See the second reaction of FIG. 4 for a schematic of this synthesis.

### Example 3A

### Preparation of SiPd1, a First Batch of Dimethylbenzylamine-Functionalized Silica Gel from 4-Benzyl-Chloride-Functionalized Silica Gel

To a 2-necked round bottom flask was added 0.1195 g (1.47 mmol) of solid dimethylamine hydrochloride and a small magnetic stir bar. The solid was dissolved in 40 mL of anhydrous DMF and 0.328 g (2.37 mmol) of K₂CO₃ was added to the solution. The solid carbonate remained-largely undissolved at the bottom of the flask, and the mixture was allowed to stir at room temperature for two hours. At that point, 0.614 g of 4-benzyl chloride functionalized silica gel (0.737 mmol Cl) was added to the reaction mixture along with an additional 0.11 g (0.8 mmol) K₂CO₃ and the flask was equipped with a reflux condenser and thermometer. The mixture was heated to 100° C. in an oil bath and gently stirred to avoid crushing the polymer for four days. The silica was then filtered and washed with excess water to dissolve all residual K₂CO₃ followed by washing with 100 mL of methanol. The pale yellow silica was immersed in a solution of 0.1M sodium methoxide in methanol overnight to remove traces of acid and cap any residual benzylchloride functionality. The silica was filtered, washed with methanol (100 mL) and dried in an oven at 60° C. for 24 hours. See the first reaction of FIG. 4 for a schematic of this synthesis.

### Example 3B

### Preparation of SiPd2, a Second Batch of Dimethylbenzylamine-Functionalized Silica Gel from 4-Benzyl-Chloride-Functionalized Silica Gel

To a heavy-walled glass pressure tube fitted with a Teflon screw cap was added 0.25 g 4-benzyl chloride functionalized silica gel (3.0×10⁻⁴ mol Cl) and the gel was suspended in 10 mL of a 2.0 M solution of dimethylamine in THF (0.02 mol dimethylamine, 67 eq.). The tube was sealed and heated in an oil bath at 80° C. for 72 hours. The crude product gel was isolated by filtration and washed with 100 mL of methanol. It was then suspended in a 7 mM solution of NaOCH₃ in methanol overnight to remove all traces of acid. The resulting gel was washed by Soxhlet extraction with THF overnight and dried at 60° C. for 24 hours. See the first reaction of FIG. 4 for a schematic of this synthesis.

### Example 3C

### Preparation of SiPd3, a Third Batch of Dimethylbenzylamine-Functionalized Silica Gel from 4-Benzyl-Chloride-Functionalized Silica Gel

To a heavy-walled glass pressure tube fitted with a Teflon screw cap was added 1.0786 g 4-benzyl chloride functionalized silica gel (1.3 mmol Cl) and the gel was suspended in 20 mL of a 2.0 M solution of dimethylamine in THF (0.04 mol dimethylamine, 31 eq.). To the mixture was added 0.4768 g (1.3 mmol) Bu₄NI. The tube was sealed and heated in an oil bath at 80° C. for 72 hours. The crude product gel was isolated by filtration and washed with 100 mL of methanol. It was then suspended in a 7 mM solution of NaOCH₃ in methanol overnight to remove all traces of acid. The resulting gel was washed by Soxhlet extraction with HOCH₃ overnight and dried at 60° C. for 24 hours. See the first reaction of FIG. 4 for a schematic of this synthesis.

### Example 4

### Palladation of Dimethylbenzylamine Functionalized Silica

Red solid PdCl₂ (0.141 g, 0.8 mmol) and anhydrous acetonitrile (20 mL) were added to a Teflon® centrifuge tube. The solid was only sparingly soluble. To the mixture was added Ag(OTf) (0.412 g, 1.6 mmol, 2 eq.). Immediately, formation of a thick beige precipitate (AgCl₍ₛ₎) was observed. A magnetic stir bar was added to the tube and the mixture was stirred vigorously, for two hours until all of the red solid PdCl₂ was consumed. The thick beige precipitate was separated by centrifugation from a yellow supernatant. The supernatant was transferred to a 50 mL round bottom flask containing dimethylamine-functionalized silica (0.67 g) (see Example 3A-C). Almost immediately after addition of the palladium solution, the pale yellow dimethylamine-functionalized silica began to darken. The reaction flask was equipped with a small magnetic stir bar and a reflux condenser and the two-phase mixture was heated to reflux for 24 hours. After cooling, a black product was isolated by filtration, was washed with 100 mL of methanol, and dried at 60° C. for 24 hours. See the second reaction of FIG. 4 for a schematic of this synthesis.

### Example 5

### Preparation of N-Iso-Propylmorpholine Buffer

To a 250 mL volumetric flask was added N-iso-propylmorpholine (0.213 g, 1.65 mmol). To the flask was then added 100 mL of methanol and the mixture was swirled to thoroughly mix the solution. To the solution was then added 72.4 microliters of 11.4 M HClO₄ in H₂O (perchloric acid, 0.825 mmol 0.5 eq) and the solution was again swirled until thoroughly mixed. The solution was then diluted to 250 mL with methanol.

### Example 6

### Analysis of Palladium Loading

Samples of palladium loaded materials PSPd and SiPd (0.01 g-0.1 g) were weighed into crucibles and burned in a muffle furnace at 500° C. for four hours. The residual ash in the crucibles was dissolved in 4 mL of aqua regia (1 mL HNO₃+3 mL conc. HCl) and heated to 150° C. for four hours on a hot plate to solubilize the palladium. The acid solutions were diluted with distilled water in a volumetric flask (10 mL-100 mL) and analyzed for palladium at the Queen's Analytical Services Unit (Queen's University at Kingston, Kingston, Ontario, Canada) using a Varian AX-Vista Pro Inductively Coupled Plasma—Optical Emission Spectrometer (available from Varian of Palo Alto, Calif., USA). Samples were analyzed by monitoring the palladium line at 360.955 nm. The palladium content was determined based on a four point calibration curve using indium and scandium as internal standards. The amount of palladium in each batch is reported in Table 1.

### Example 7

### Kinetic Studies of Immobilized Catalysts

All kinetic experiments with immobilized catalysts were conducted in 2.5 mL of a methanol solution buffered with N-iso-propylmorpholine (6.6 mM) at ₛ^{s}pH=8.8±0.4 (Gibson, G.; Neverov, A. A.; Brown, R. S. Can J. Chem. 2003, 81, 495).

The rate of methanolysis of 2 (1×10⁻⁵ M) was monitored by the rate of loss of absorbance at 265 nm and the rate of appearance of the phenoxide product at 310 nm. The rate of disappearance of 4 (1×10⁻⁴ M) was followed at 220 nm and the appearance of product was observed at 295 nm. For substrates 5 and 6 (1×10⁻⁴ M and 1.5×10⁻⁴ M) the rates of starting material disappearance were observed at 293 and 245 nm and appearance of product from 5 at 195 nm. All reactions were monitored using a Cary 100 UV-vis spectrophotometer with the cell compartment thermostatted at 25.0±0.1° C. In a representative example monitored by uv/vis spectrophotometry, 0.05 g of PSPd2 was added to a quartz cuvette. In a separate vial, 25 μL of a 1×10⁻³ M stock solution 2 in methanol was added to 2.5 mL of N-iso-propylmorpholine buffered (6.6×10⁻³ M) methanol to give a final substrate concentration of 1×10⁻⁵ M. This solution was transferred to a uv/vis cuvette and immediately placed in the spectrometer to obtain a time-zero absorbance. Every minute, the cell was removed and shaken for 13 seconds (˜30 times) and replaced in the spectrometer for a short time (one to five seconds to allow settling) before collecting a new absorbance spectrum from 200-400 nm over 27 seconds). The reactions were run to completion and the pseudo-first-order rate constants (k_{obs}) were determined by fitting the absorbance vs. time traces to a standard exponential model. As discussed later, the actual catalyzed reaction required agitation of the solutions and control experiments establish that the reactions are at least 100 times slower when the catalysts are settled to the bottom of the cuvettes. Thus, only the time in which the reaction mixtures were actually shaken were used for the absorbance vs time profile shown in FIG. 1. Control experiments in which 0.05 g of non-functionalized chloromethylated polystyrene and 4-benzylchloride functionalized silica gel were used as catalysts for the methanolysis of 2 showed no conversion of starting material to product, confirming that the reactions observed when PSPd and SiPd are catalysts are due solely to the palladacycle complex and not to the solid matrix.

### Example 8

### Catalytic Studies

Catalytic activity of the materials was determined for the methanolysis of the P═S phosphorothioate triesters 2, 4-6. The reaction rates were determined by measuring the change in UV-vis absorbance for both the loss of starting material and formation of product in methanol solutions containing a known quantity of solid catalyst. The immobilized catalyst (0.009-0.09 g) was put into 2.5 mL of methanol solution buffered at ₛ^{s}pH=8.8 by N-iso-propylmorpholine (6.6×10⁻³ M). In each case, the concentration of the catalytic complex was determined as if the solid materials were completely dissolved in the reaction solution (denoted [Pd]_{T}). Under this assumption, the palladium concentration ranged between 8.9×10⁻⁵ M and 7.6×10⁻³ M when all experiments are considered.

In all reactions, the observed change in absorbance followed good pseudo-first-order behaviour and yielded first-order rate constants, k_{obs}, based on fitting of the Abs. vs. time curve (e.g. for 2 shown in FIG. 1) to a standard exponential model. In Tables 2 and 3 are given the k_{obs} values (normalized for 50 mg of catalyst), the apparent second-order rate constants for the methanolysis of substrates 2, and 4-6 catalyzed by PSPd and SiPd respectively where the apparent second-order rate constants are defined as k_{obs}/[Pd]_{T}.

Plots of the k_{obs} rate constants for the methanolysis of 2 catalyzed by PSPd2 and SiPd1 at ₛ^{s}pH=8.8 as a function of the weight of catalyst (FIG. 2) are, within experimental uncertainty, linear and show no obvious saturation kinetics over the weight range investigated which is consistent with what was observed for the methanolysis of 2 catalyzed by complex 3 in solution (Lu, Z.-L.; Neverov, A. A.; Brown, R. S. Org. Biomol. Chem. 2005, 3, 3379).

Interestingly, the observed rate constants for the methanolysis of 2 catalyzed by the higher loading silica catalyst (SiPd2) were lower than those obtained with the original batch of silica catalyst (SiPd1) despite the fact that the SiPd2 material contained a higher analytical loading of Pd. We note that the analysis is for total Pd and does not distinguish between that in the palladacycle and that which may be in the form of palladium black or Pd⁰ nanoparticles which may also be adsorbed by the silica support. This may signify that there is no apparent advantage to a higher loading. Despite the lower palladium content of the silica based catalyst (SiPd1), the first-order rate constants for the methanolysis of all substrates were greater by roughly a factor of 2 to 3 in comparison to the polystyrene based catalysts (PSPd). When corrected for the Pd loading to determine the apparent second-order rate constants for the catalyzed reaction, the silica catalysts are about 2 to 10-fold better than the polystyrene one which is a little surprising given the 10-20 fold less amount of Pd on the silica based catalyst. Perhaps this is due to the larger concentration of accessible reactive sites on the surface of the silica particles in comparison to the polystyrene beads or to the fact that the silica surface is hydrophilic which should allow the methanol solvent to surround the catalytic groups on the silica surface. The polystyrene is hydrophobic and thus has the opposite effect of repelling the methanol from the surface groups (see Corma, A; Garcia, H Topics in Catalysis 2008, 48, 8-31). Although the functionalization of the commercial chloromethylated polystyrene was performed in DMF and the cyclopalladation performed in acetronitrile (two solvents which are known to swell polystyrene), the solvolysis reactions are conducted in methanol which is a solvent that does not swell polystyrene appreciably. In the case of silica gel, the reactive palladacycle complexes are probably concentrated on the outer surface of the particles and hence much more accessible to methanol, while in the case of polystyrene many of the reactive sites may be buried within the polymeric matrix and the hydrophobic surface may present a barrier to bringing the solvent close to the surface attached catalytic groups and those more inaccessible in the interior.

While the second-order rate constant for 3 (where a methoxide group is present in place of the triflate group that is shown in FIG. 5 for complex 3) promoted methanolysis of substrates 2, 4-6 in solution (see Tables 2 and 3) range between 0.45 M⁻¹s⁻¹ for 6 and 146.7 M⁻¹s⁻¹ for 5 (a 326-fold difference), the second-order rate constants for methanolysis of the same substrates promoted by the supported catalysts' reactions differ only by factors of ˜1.8 and 2.6 for PSPd2 and SiPd1 respectively, and none of the reactivities of 2, 4-6 follow the trend observed in solution. Notably, diazinon (6), which is by far the least reactive substrate toward 3 (also methoxide form, as above) in solution, appears to be more effectively decomposed by the solid supported materials by a factor of eight and 73 for PSPd2 and SiPd1 respectively. All these observations are consistent with a reaction scheme in which mass transport between the solution and the polymer or silica matrix, and not the chemical transformation, is rate limiting, leading to observed rate constants which are relatively insensitive to the nature of the substrate.

It is notable that the solid supported palladacycles operate at near neutral pH values in methanol where the background methoxide-promoted reactions are very slow. This is an attractive feature of the system for removal of this sort of pesticide from sensitive surfaces which may corrode easily under highly alkaline conditions. Comparing the reactions for 2 (k₂^{OMe}=(7.2±0.2)×10⁻⁴ M⁻¹s⁻¹) (Neverov, A. A.; Brown, R. S. Org. Biomol. Chem. 2004, 2, 2245) at ₛ^{s}pH 8.8, 50 mg of PSPd2 or SiPd1 provides a 33×10⁹-fold and 8.6×10⁹-fold acceleration when in excess of the substrate.

A turnover experiment was performed in order to demonstrate that the solid materials are indeed catalytic. A small amount of SiPd1 catalyst in 2.5 mL of methanol (6.2 mg, 8.9×10⁻⁵ M=[Pd]ₜ) was used to catalyze the methanolysis of 3.4×10⁻⁴ M ([2]=3.8[Pd]_{T}) buffered at ₛ^{s}pH=8.8 with N-iso-propylmorpholine (6.6×10⁻³ M). The UV-vis absorbance showed a complete loss of substrate and release of product with good first-order kinetics (k_{obs}=0.092 min⁻¹) and no observed product inhibition. In this case, for the entire reaction under turnover conditions, the acceleration for the degradation of 2 relative to the background reaction at ₛ^{s}pH=8.8 was 2.1×10⁸-fold. Compared with the data in Table 3, entry 1 for the reaction of 2 with 50 mg of SiPd1, and excess relative to the substrate, where k₂=86 M⁻¹s⁻¹, the data obtained with the substrate in excess of catalyst (k₂=17.2 M⁻¹s⁻¹) indicate that there is a reduction of ˜5-fold in the rate constant. That the reactions conducted under turnover conditions are somewhat slower than when the catalyst is in excess of substrate, was also observed for the methanolysis of 2 promoted by 3 under turnover conditions (see Lu, Z.-L.; Neverov, A. A.; Brown, R. S. Org. Biomol. Chem. 2005, 3, 3379). From the data presented in Lu et al., when turnover experiments are conducted with [2]=7.3×10⁻³ M and [3]=1.5×10⁻⁴ M at ₛ^{s}pH 10.8 in triethylamine buffer, the k₂ value is 36.9 M⁻¹s⁻¹; When in excess of substrate, the k₂ value determined for reaction of 2 with 3 at ₛ^{s}pH 10.8 by visible spectrophotmetry is 1880 M⁻¹s⁻¹, while that determined under turnover conditions by ¹H NMR is 36.9 M⁻¹s⁻¹. The drop in reactivity was attributed in Lu et al. to the large concentration of inhibitory buffer in the NMR experiment which was required to control the ₛ^{s}pH, as well as the larger concentrations of substrate (7×10⁻² M) and catalyst which can alter the solution properties. It is possible, however, that the diminution of rate is attributable to a saturation binding of substrate and reaction product with the catalyst.

Thus the observed turnover second-order rate constant for methanolysis, catalyzed by SiPd1, of fenitrothion (2) was 3.7 M⁻¹s⁻¹ (based on the total amount of Pd on 6.5 mg of silica), which was about 23 times lower than that determined for the kinetic determination with an excess amount (50 mg) of functionalized silica given in Table 3, entry 1. The reduction in the observed rate of reaction with increasing substrate concentration might be indicative of a saturating transport phenomenon.

### Example 9

### Catalyst Recycling

Advantages of polymer/solid supported catalysts include the ability to store and to reuse the catalyst when recovered from the reaction mixture (Leadbeater, N. E.; Marco, M. Chem. Rev. 2002, 102, 3217; Bergbreiter, D. E.; Osburn, P. L.; Wilson, A.; Sink, E. M. J. Am. Chem. Soc. 2000, 122, 9058; Bergbreiter, D. E.; Osbum, P. L.; Liu, Y.-S. J. Am. Chem. Soc. 1999, 121, 9531; McNamara, C. E.; King, F.; Bradley, M. Tetrahedron Lett. 2004, 45, 8239; Bergbreiter, D. E. Chem. Rev. 2002, 102, 3345; Dijkstra, H. P.; Slagt, M. Q.; McDonald, A.; Kruithof, C. A.; Kseiter, R.; Mills, A. M.; Lutz, M.; Speck, A. L.; Klopper, W.; and Van Klink G. P. M.; Van Koten, G. J. Catal. 2005, 229, 322). As a control experiment to test the effects of catalyst storage, the methanolysis of 2 was conducted using two batches of PSPd2, one of which was dried and stored in air, and a second that was stored for five days in N-iso-propylmorpholine buffer (6.6×10⁻³ M) at ₛpH=8.8. A reaction was conducted in which 0.0488 g of PSPd2, soaked in buffer, was used to catalyze the methanolysis of 2. The catalyst was soaked in N-iso-propylmorpholine buffer (6.6×10⁻³ M) at ₛ^{s}pH=8.8 in a quartz cuvette for five days. After this period, the buffer solution was decanted and the catalyst was washed with three portions of clean methanol (3 mL each). To the cell was then added 2.5 mL of a 1×10⁻⁵M solution of 2 in N-iso-propylmorpholine buffer (6.6×10⁻³ M) at ₛ^{s}pH=8.8. This experiment gave the same observed rate constant (within experimental error) for the methanolysis of 2 as obtained with catalyst which was dried and stored in air (see Table 2).

The reusability of the immobilized catalysts was demonstrated by performing a series of sequential methanolysis reactions with the same sample of catalyst. Shown in FIG. 3 are ten consecutive reactions with 1×10⁻⁵ M fenitrothion (2) promoted by both PSPd2 and SiPd1. Each experiment involved following the time course of the reaction to completion, removal of the reaction solution from the cuvette by careful pipetting, washing the solid material in the cuvette with five portions of clean methanol (3 mL each), each of which was removed by careful pipetting, and then charging the remaining solid with 2.5 mL of buffer along with inoculation with 1×10⁻⁵ M 2 and remonitoring the reaction.

Given the assessment of the activity as a function of time, both catalysts show a good stability to reuse. There may be some loss of activity due to the washing cycles, where loss of more flocculent solid could have occurred which might account for the gradual diminution and apparent plateauing of activity. As shown in Table 1, the PSPd catalysts typically undergo some leaching of palladium upon the first use of the material, but no significant decrease in the catalytic activity of the remaining material was observed suggesting that this loss represents desorption of a catalytically inactive palladium species which was adsorbed to the polymer matrix. In the case of the SiPd materials, the palladium contents before and after the first reaction do not differ. In the case of the silica based materials, the palladium contents before and after the first reaction do not differ so if there is adsorbed Pd⁰, it must be more strongly adsorbed than in the case of the polystyrene supported catalysts, for reasons that are unclear at present.

To further demonstrate the truly heterogeneous nature of the catalysts and to confirm the robustness of the immobilized palladium species, leaching experiments were conducted to show that all of the observed catalysis is due to immobilized palladium, and not due to palladium free in solution. Samples of PSPd3 and SiPd1 (0.035 g and 0.033 g respectively) were added to separate UV cuvettes and to each was added 2.5 mL of a 1×10⁻⁵M solution of 2 in N-iso-propylmorpholine buffer (6.6×10⁻³ M) at ₛ^{s}pH=8.8. The reactions were monitored and allowed to progress to ˜50% completion at which point the reaction solution was carefully removed from the cuvette and transferred to a clean cuvette. The cuvettes containing the reaction solution were replaced into the spectrometer and monitored over the next 15 minutes. During this time, no change was observed in the UV spectrum of either reaction solution indicating that in the absence of solid catalyst the reactions proceed only at their slow background rate. Reintroduction of the reaction solutions into the cuvettes containing the solid catalyst and monitoring the UV spectrum showed continuation of the initial reaction until all of the substrate disappeared.

### Example 10

### Methanolysis of Malathion

The structures of substrates 2, 4-6, with leaving group chromophores, makes their reactions convenient to study using UV/vis spectrophotometry, but these are not as widely used as some other P═S pesticides such as malathion (8). 8 is the most commonly used organophosphorus insecticide in the United States (Bonner, M. R.; Coble, J.; Blair, A.; Beane Freeman, L. E.; Hoppin, J. A.; Sandler, D. P.; Alavanja, M. C. R. Am. J. Epidemiol. 2007, 166, 1023) for applications ranging from protection of agricultural crops to the treatment of head lice. While it has relatively low toxicity in humans, the major oxidative metabolite and contaminant in the commercial product is malaoxon (9) which is roughly 10-60 times more toxic for mammals. The wide-spread use of malathion, the toxicity of its metabolite and its slow rate of spontaneous hydrolysis makes it an appealing target for catalytic degradation.

Since 8 does not contain a chromophore, its methanolysis reactions were followed using ³¹P NMR. A solution of 8 (5.15×10⁻³ M) was prepared in an NMR tube in 0.8 mL of a 1:1 mixture of normal methanol containing N-iso-propylmorpholine buffer (6.6×10⁻³ M) and CD₃OD. The substrate appears in the ³¹P spectrum at δ 96.43 ppm. The catalyst (PSPd3, 0.0436 g) was added to the NMR tube, giving [Pd]_{T}=31.6×10⁻³ M, and the tube was shaken for 30 seconds. After 5 minutes the ³¹P spectrum was recorded and showed a new signal corresponding to the methanolysis product (O,O,O-trimethyl phosphorothioate) emerging at δ 74.26 ppm (lit. 73.91 ppm from Greenhalg, R.; Shoolery, J. N. Anal. Chem. 1978, 50, 2039). Collection of the ³¹P spectrum was repeated after 14 minutes and 24 minutes. After 24 minutes, the peak corresponding to the substrate at δ 96.43 ppm was completely replaced by the product peak at δ 74.26 ppm.

An analogous experiment in which 0.0426 g of SiPd1 was used as the catalyst ([Pd]_{T}=1.9×10⁻³ M) showed an initial conversion of starting material to product, but failed to decompose all of the substrate after 30 minutes suggesting catalyst inhibition. This is consistent with an earlier ³¹P NMR experiment using PSPd2 which rapidly decomposed an amount of 8 equal to half of the palladium content. Addition of a second aliquot of 8 generated its customary signal at δ 96.41 ppm, however the ³¹P spectrum recorded 60 minutes after the addition of the second portion of substrate showed no decrease in the starting material and no additional product signal was observed. After a period of 96 hours (4 days), 64% of the substrate was converted to product and after 264 hours (11 days), the ³¹P NMR showed no sign of starting material and the product peak at δ74.26 ppm.

Incomplete conversion by SiPd1 and the prolonged reaction time for the methanolysis of the second portion of 8 by PSPd2 is attributed to inhibition by the thiol product. In the case of substrates 2, 4-6 product inhibition was not observed, even in the presence of excess substrate since the leaving groups were all substituted phenols, where the hydroxyl group oxygen is a hard ligand and does not bind strongly to the soft palladium centre (Smith, B.; March, J. Advanced Organic Chemistry. Fifth Ed., Wiley Interscience, New York, 2001, pp. 338-342). However, in the case of 8, the leaving group is diethyl thiomalate which binds strongly to palladium via sulfur. As expected, analysis of the reaction solution from the catalyzed methanolysis of 8 by mass spectrometry showed the presence of the O,O,O-trimethyl phosphorothioate product at m/z=156 with 34% intensity, but not the diethyl thiomalate. The fact that a less than a stoichiometric amount of 8 strongly inhibited the polystyrene-bound palladacycle supports our hypothesis that the metal containing sites have variable accessibility to solvent and substrate, such that only the accessible ones are inhibited by the reaction product.

TABLE 1
Palladium and nitrogen content of immobilized catalysts
as analyzed by Inductively Coupled Plasma - Optical Emission
spectroscopy and microanalysis, respectively

| Catalyst | Pd source | Pd content (mmol/g) ^{a, b} | N content (mmol/g) ^{c} |
|---|---|---|---|
| PSPd1 | Li₂PdCl₄ | 0.85 (0.57) | NA |
| PSPd2 | PdCl₂ | 0.40 (0.21) | NA |
| PSPd3 | PdCl₂ | 0.58 | 1.55 |
| SiPd1 | PdCl₂ | 0.036 | 0.5 |
| SiPd2 | PdCl₂ | 0.20 | 1.03 |
| SiPd3 | PdCl₂ | 0.075 | 0.74 |

^{a} The value quoted is the Pd content before the material was used in a reaction. The value in brackets represents the Pd content after the first use of catalyst in solution.
^{b} Error limits are considered to be ±15% of the reported value based on replicate measurements and detection instrument error.
^{c} N loading determined by microanalysis; NA = not analyzed.

TABLE 2
First-order and apparent second-order rate constants for the
methanolysis of phosphorothioate triesters catalyzed by polystyrene-
bound palladacycle (PSPd2) in methanol buffered at ₛ^{s}pH = 8.8
by N-iso-propylmorpholine (6.6 × 10⁻³ M), T = 25° C.

| | k_{obs} (s⁻¹) for 50 mg | k₂ | Solution k₂ | K₂^{OMe} |
|---|---|---|---|---|
| Substrate ^{a} | of polymer ^{b} | (M⁻¹s⁻¹) ^{c, d} | (M⁻¹s⁻¹) ^{e} | (M⁻¹s⁻¹) |
| 2 | 2.68 × 10⁻² | 6.4 | 36.9 | 7.2 × 10⁻⁴ |
| 4 | 2.15 × 10⁻² | 5.1 | 44.3 | 1.7 × 10⁻⁴ |
| 5 | 2.07 × 10⁻² | 4.9 | 146.7 | 7.5 × 10⁻⁴ |
| 6 | 1.63 × 10⁻² | 3.7 | 0.45 | 5.8 × 10⁻⁴ |

^{a} [2] = 1 × 10⁻⁵ M, [4] = 1 × 10⁻⁴ M, [5] = 1 × 10⁻⁴ M, [6] = 1.5 × 10⁻⁴ M
^{b} for 50 mg of PSPd2 in 2.5 mL of solution, [Pd]_{τ} = 4.2 × 10⁻³ M
^{c} Error limits are considered to be ±20% based on errors in the determination of palladium loading and uncertainties in duplicate rate measurements
^{d} k₂ is defined as k_{obs}(s⁻¹)/[Pd]_{τ}(M)
^{e} Second-order rate constants for the methanolysis of substrates 2, 4-6 catalyzed by 3 at ₛ^{s}pH 10.8 (see Lu et al., 2005).

TABLE 3
First-order and apparent second-order rate constants for the
methanolysis of phosphorothionate triesters catalyzed by silica-
gel bound palladacycle (SiPdl) in methanol buffered at ₛ^{s}pH =
8.8 by N-iso-propylmorpholine (6.6 × 10⁻³ M). T = 25° C.

| | k_{obs}(s⁻¹) for 50 mg | k₂ | Solution k₂ | k₂^{OMe} |
|---|---|---|---|---|
| Substrate^{a} | of silica^{b} | (M⁻¹s⁻¹)^{c,d} | (M⁻¹s⁻¹)^{e} | (M⁻¹s⁻¹) |
| 2 | 6.22 × 10⁻² | 86.3 | 36.9 | 7.2 × 10⁻⁴ |
| 2 | 4.8 × 10^{-2f} | 12.4 | 36.9 | 7.2 × 10⁻⁴ |
| 2 | 3.02 × 10^{-2g} | 21.0 | 36.9 | 7.2 × 10⁻⁴ |
| 4 | 4.13 × 10⁻² | 57.5 | 44.3 | 1.7 × 10⁻⁴ |
| 5 | 4.07 × 10⁻² | 56.58 | 146.7 | 7.5 × 10⁻⁴ |
| 6 | 2.38 × 10⁻² | 33.12 | 0.45 | 5.8 × 10⁻⁴ |

^{a}[2] = 1 × 10⁻⁵ M, [4] = 1 × 10⁻⁴ M, [5] = 1 × 10⁻⁴ M, [6] = 1.5 × 10⁻⁴ M.
^{b}for 50 mg of SiPd1 in 2.5 mL of solution, [Pd]_{τ} = 7.2 × 10⁻⁴ M.
^{c}Error limits are considered to be ±20% based on errors in the determination of palladium loading and uncertainties in duplicate rate measurements.
^{d}k₂ is defined as k_{obs}(s⁻¹)/[Pd]_{τ}(M).
^{e}Second-order rate constants for the methanolysis of substrates 2, 4-6 catalyzed by (N,N-dimethylaminobenzyl-C¹,N)(pyridine)palladium(II)triflate (3) at ₛ^{s}pH 10.8 (see Lu et al., 2005).
^{f}The methanolysis reaction was catalyzed by SiPd2 (0.2 mmol/g Pd) for which 50 mg in 2.5 mL of solution gives [Pd]_{T} = 4.0 × 10⁻³ M.
^{g}Methanolysis reaction promoted by SiPd3 (0.075 mmol/g Pd) for which 50 mg in 2.5 mL of solution gives [Pd]ₜ = 1.44 × 10⁻³ M.

### REFERENCES

Baleizão, C.; Comm, A.; Garcia, H.; Leyva, A. J. Org. Chem. 2004, 69, 439.
Bedford, R. B.; Coles, S. J.; Hursthouse, M. B.; Scordia, V. J. M. J. Chem. Soc. Dalton Trans. 2005, 5, 991.
Bedford, R. B.; Cazin, C. S. J.; Hursthouse, M. B.; Light, M. E. Pike, K. J.; Wimperis, S. J. Organometal. Chem. 2001, 633, 173.
Bergbreiter, D. E.; Osburn, P. L.; Wilson, A.; Sink, E. M. J. Am. Chem. Soc. 2000, 122, 9058.
Bergbreiter, D. E.; Osburn, P. L.; Liu, Y.-S. J. Am. Chem. Soc. 1999, 121, 9531.
Bergbreiter, D. E. Chem. Rev. 2002, 102, 3345.
Bonner, M. R.; Coble, J.; Blair, A.; Beane Freeman, L. E.; Hoppin, J. A.; Sandler, D. P.; Alavanja, M. C. R. Am. J. Epidemiol. 2007, 166, 1023.
Bosch, E.; Rived, F.; Roses, M.; Sales, J., J. Chem. Soc., Perkin Trans. 2, 1999, 9, 1953.
Bosch, E.; Beu, P.; Allemann, H.; Rosés, M. Anal. Chem. 1996, 68(20), 3651.
Chauvin, Y.; Commereuc, D.; Dawans, F. Prog. Polym. Sci. 1977, 5, 95.
Corma, A.; Das, D.; Garcia, H.; Leyva, A. J. Catal. 2005, 229, 322.
Corma, A.; Garcia, H.; Leyva, A. J. Catal. 2006, 240, 87.
Corma, A; Garcia, H Topics in Catalysis 2008, 48, 8-31.
Didier, B.; Mohamed, M. F.; Csaszar, E.; Colizza, K. G., Neverov, A. A.; Brown, R. S. Can. J. Chem. 2008, 86, 1.
Dijkstra, H. P.; Slagt, M. Q.; McDonald, A.; Kruithof, C. A.; Kreiter, R.; Mills, A. M.; Lutz, M.; Speck, A. L.; Klopper, W.; Van Klink G. P. M.; Van Koten, G. Eur. J. Inorg. Chem. 2003, 5, 830.
Gibson, G.; Neverov, A. A.; Brown, R. S. Can. J. Chem. 2003, 81, 495.
Greenhalg, R.; Shoolery, J. N. Anal. Chem. 1978, 50, 2039.
Grigor'ev, V. V.; Dovnarovich, N. A.; Letashkov, A. V.; Ptashnikov, Yu. L.; Sagaidak, D. I. “Study of the formylation of polystyrene”, Nauchno-Issled. Inst. Prikl. Fiz. Probl. im. Sevchenko, Minsk, USSR. Vysokomolekulyarnye Soedineniya, Seriya B: Kratkie. Soobshcheniya (1987), 29(1), 19-21.
Guyot, A. Pure Appl. Chem. 1988, 60, 365.
Leadbeater, N. E.; Marco, M. Chem. Rev. 2002, 102, 3217.
Lu, Z.-L; Neverov, A. A.; Brown, R. S. Org. Biomol. Chem. 2005, 3, 3379.
McNamara, C. E.; King, F.; Bradley, M. Tetrahedron Lett. 2004, 45, 8239.
Nowotny, M.; Hanefeld, U.; van Koningsveld, H.; Maschmeyer, T. Chem. Comm. 2000, 19, 1877.

Rived, F.; Rosés, M.; Bosch, E., Anal. Chim. Acta 1998, 374, 309.
Ryabov, A.; Polyakov, V. A.; Yatsimirsky, A. K. J. Chem. Soc., Perkin Trans. 2. 1983, 10, 1503.
Smith, B.; March, J. Advanced Organic Chemistry. Fifth Ed., Wiley Interscience, New York, 2001, pp. 338-342.
U.S. Pat. No. 3,594,333.
U.S. Pat. No. 7,214,836.

1. A method of preparing a heterogeneous catalyst comprising:
providing solid polymeric material comprising a main chain and a plurality of pendant groups, each pendant group having a first point of attachment suitable for bonding to a metal atom;
reacting the solid polymeric material to provide modified solid polymeric material, wherein the modified solid polymeric material comprises a plurality of modified pendant groups, each having the first point of attachment and a second point of attachment suitable for bonding to a metal atom, which second point of attachment is proximal to the first point of attachment;
reacting the modified solid polymeric material with metal; and
obtaining a heterogeneous catalyst comprising metal bound to solid polymeric material at at least the first and the second points of attachment of two or more of the modified pendant groups.

2. (canceled)

3. The method of claim 1, wherein the metal is metal(0) or metal(II).

4. The method of claim 1, wherein the metal is palladium, platinum, nickel, iron, rhodium, yttrium, ruthenium, osmium, iridium, rhodium, titanium, zirconium, or gold.

5. (canceled)

6. The method of claim 1, wherein a said pendant group comprises a functional moiety that is either zero or one atom from the main chain, wherein the functional moiety comprises the first point of attachment.

7. (canceled)

8. (canceled)

9. The method of claim 1, wherein the heterogeneous catalyst comprises at least one carbon-metal bond.

10. The method of claim 1, wherein the heterogeneous catalyst comprises at least one heteroatom-metal bond.

11. (canceled)

12. The method of claim 1, wherein the solid polymeric material is halomethylated polystyrene or halobenzyl-functionalized silica gel.

13. (canceled)

14. (canceled)

15. (canceled)

16. (canceled)

17. (canceled)

18. (canceled)

19. The method of claim 1, wherein the heterogeneous catalyst comprises a plurality of metallocycles.

20. (canceled)

21. (canceled)

22. (canceled)

23. (canceled)

24. (canceled)

25. (canceled)

26. A method of preparing a heterogeneous catalyst comprising:
providing chloromethylated polystyrene comprising a main chain and a plurality of chlorobenzyl pendant groups, each pendant group having an ortho carbon;
reacting the chloromethylated polystyrene to provide dimethylaminomethylene polystyrene comprising a plurality of dimethylaminobenzyl pendant groups, each having the ortho carbon and an amine nitrogen, which nitrogen is proximal to the ortho carbon;
reacting the dimethylaminomethylene polystyrene with Pd(II); and
obtaining a heterogeneous catalyst comprising Pd bound to polystyrene at least the ortho carbon and the amine nitrogen of two or more pendant groups.

27. A method of preparing a heterogeneous catalyst comprising:
providing chlorobenzyl functionalized silica comprising a main chain and a plurality of chlorobenzyl pendant groups, each pendant group having an ortho carbon;
reacting the chlorobenzyl functionalized silica to provide dimethylaminobenzyl functionalized silica comprising a plurality of dimethylaminobenzyl pendant groups, each having the ortho carbon and an amine nitrogen, which nitrogen is proximal to the ortho carbon;
reacting the dimethylaminobenzyl functionalized silica with Pd(II); and
obtaining a heterogeneous catalyst comprising Pd bound to solid polymeric material at least the ortho carbon and the amine nitrogen of two or more dimethylaminobenzyl pendant groups.

28. (canceled)

29. (canceled)

30. A heterogeneous catalyst prepared by the method of claim 1.

31. Use of the heterogeneous catalyst of claim 30 to catalyze decomposition of a P═S phosphorothioate compound.

32. The use of claim 31, wherein the P═S phosphorothioate compound is fenitrothion, dichlofenthion, coumaphos, diazinon, quinalphos, or malathion.

33. (canceled)

34. (canceled)

35. A method of decomposing a P═S phosphorothioate compound comprising:
providing a heterogeneous catalyst as claimed in claim 30; and
contacting an appropriately buffered solution comprising alcohol and a P═S phosphorothioate starting material with the heterogeneous catalyst;
wherein the P═S phosphorothioate starting material is at least partially decomposed.

36. (canceled)

37. A kit for heterogeneous catalysis comprising a heterogeneous catalyst as claimed in claim 30, an appropriately buffered solution, and instructions for use.

38. An immobilized ortho palladacycle comprising: 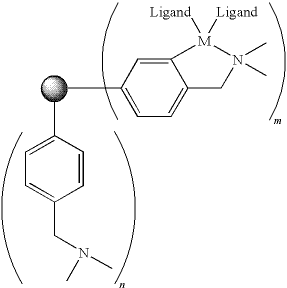
where 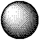
is a polymeric moiety that is covalently bonded to 4-benzyldimethylamine pendant groups;
m is 1 to a large number;
n is 0 to a large number;
M is a metal atom; and
Ligand is a moiety that transiently occupies valence positions on M that are available for reaction.

39. The immobilized ortho palladacycle of claim 38, where m is 2 to a large number.

40. The immobilized ortho palladacycle of claim 38, wherein the polymeric moiety is silica.

41. The immobilized ortho palladacycle of claim 38, wherein M is Pd(II).

42. The immobilized ortho palladacycle of claim 38, wherein Ligand is methoxide, methanol, ethoxide, ethanol, 1-propoxide, 1-propanol, 2-propoxide, 2-propanol, acetonitrile, THF, furan, or OTf.

43. An immobilized ortho palladacycle as shown below, comprising: 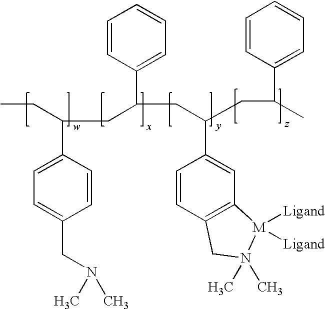
where
w, x and z are independently 0 to a large number;
y is 1 to a large number;
M is a metal atom; and
Ligand is a moiety that transiently occupies valence positions on M that are available for reaction.

44. The immobilized ortho palladacycle of claim 43, wherein y is 2 to a large number.

45. The immobilized ortho palladacycle of claim 43, wherein M is Pd(II).

46. The immobilized ortho palladacycle of claim 43, wherein Ligand is methoxide, methanol, ethoxide, ethanol, 1-propoxide, 1-propanol, 2-propoxide, 2-propanol, THF, furan, or OTf.
